(19) United States
(12) Patent Application Publication
(10) Pub. No.: US 2007/0124201 A1
(43) Pub. Date: May 31, 2007

(54) Digital content access system and methods

(76) Inventors: Hubert C. Hu, Redmond, WA (US); Elbert S. Hu, Rockville, MD (US); Jian-Hwa Hu, Keelung (TW)

Correspondence Address: MILES & STOCKBRIDGE PC, 1751 PINNACLE DRIVE, SUITE 500, MCLEAN, VA, 22102-3833, US

(21) Appl. No.: 11/289,495

(22) Filed: Nov. 30, 2005

(51) Int. Cl. G06Q 30/00

(52) U.S. Cl. 705/14

(57) ABSTRACT

Systems and methods for allowing access to digital content. Digital content and targeted advertisements are separately provided to a user device. At least one interactive viewer test is used to verify that the user has viewed the targeted advertisements as a prerequisite to being given the rights to playback the digital content.

This disclosure contains information subject to copyright protection. The copyright owner has no objection to the facsimile reproduction by anyone of the patent disclosure or the patent as it appears in the U.S. Patent and Trademark Office files or records, but otherwise reserves all copyright rights whatsoever.

### BACKGROUND

1. Field of Invention

The present invention relates to the field of data processing and, more specifically, methods and systems for allowing access to information.

2. Description of Related Art

Technological and societal factors such as the ubiquity of computer networks and, in particular, the Internet, as well as the increase in storage capacity and processing bandwidth available for various consumer electronics devices, have led to increasing use of digital media for the provision and exchange of audio and video information. For example, music, songs, movies, video clips, commercials, photographs, electronic books, home videos, images, and the like, are now routinely digitized (e.g., converted to digital form) and transmitted or downloaded to user devices for delivery to and/or playback by user devices. Such user devices can include, for example, but not limited to, Personal Computers (PCs), Personal Digital Assistants (PDAs), MP3 players and other portable music devices, wireless terminals, cellular telephone handsets.

The advent of such digital content being readily available for use and sharing among users and devices presents challenges to traditional retail-based business models. The music industry in particular, for example, and the film industry to a lesser extent, currently face pirating and otherwise unauthorized distribution of artistic content that heretofore was strictly controlled through the release to authorized distributors for mass market retail consumption. The ability for the mass market to circumvent these traditional channels has affected revenues for the entertainment industries and introduced uncertainties to royalty compensation incentives to artists.

While solutions have been developed for compensated delivery of digital content, these prior solutions have drawbacks. For example, prior solutions can be overly cumbersome to use in terms of procedures or performance impact. Furthermore, prior solutions may lack the ability to condition access to digital content on adequate assurance that the prospective user has accomplished a desired action, while not overly burdening the user. For example, user access to content can be unduly restricted by solutions that require a user to answer a series of questions related to the details of advertisements (e.g., “contextually-related” questions).

Thus, there is a need for systems and methods to address these limitations as well as others readily discernible from review of this disclosure.

### SUMMARY

Embodiments are directed generally to systems and methods for providing access to digital content. Various embodiments can comprise providing digital content to a user device, providing at least one targeted advertisement to the user device in which the targeted advertisement(s) comprise files that are separate from the digital content, and outputting one or more interactive viewer tests to the user device during playback of the at least one targeted advertisement. The interactive viewer test can comprise at least one question designed to solicit human user input. Further, the question(s) can be contextually unrelated to the content of the targeted advertisement(s). Various embodiments can comprise allowing playback of the digital content by the user device upon successful validation of the user responses and the order in which the user responses are received.

In various embodiments, providing digital content can comprise downloading a digital file to the user device in response to a request for the file received from the user device.

Various embodiments can also comprise outputting a continent selection page to the user device. Based on the continent selection, various embodiments can comprise outputting at least one country selection page to the user device. The country selection page(s) can comprise, for example, a first set of countries for which digital content is available. Country selections can be received from the user device indicating one or more of countries from the first set of countries. Furthermore, various embodiments can comprise outputting at least one country-specific content page to the user device comprising links to country-specific digital content. From the country-specific content page, the user can select country-specific digital content.

In various embodiments, providing the at least one targeted advertisement can comprise determining user eligibility to receive the at least one targeted advertisement based on the user device being located in a country for which targeted advertisements are available. Furthermore, each targeted advertisements can comprise one commercial segment.

Further, various embodiments can comprise receiving category selections from the user device, and the targeted advertisement(s) can be based on the received category selections. In addition, various embodiments can comprise providing a plurality of identical channels for each category and associating multiple commercial segments with each of the channels. In various embodiments, each commercial segment can have an associated segment period. The segment period can be the same for each commercial segment of a channel. The commercial segment playback start time for each channel can be offset by an amount of time equal to the segment period divided by the number of channels for the category.

Various embodiments can also comprise selecting the at least one targeted advertisement based on the location of the user device.

Various embodiments can further comprise outputting one or more advertisement links to the user device. Each of the advertisement links can be contextually related to the targeted advertisement(s). As a user selects individual advertisement link, each selected advertisement link can be collected into an ad cart at the user device. The ad cart can then be output at the user device. Various embodiments can further comprise redirecting a browser application of the user device to a Uniform Resource Locator associated with one of the advertisement links upon receiving a user selection of the advertisement link from the ad cart.

In various embodiments, the interactive viewer test can be a timed Turing test capable of distinguishing human input from non-human input. Furthermore, each interactive viewer test can comprise outputting one timed Turing test to the user device and receiving one user response for the interactive viewer test.

In various embodiments, outputting the at least one interactive viewer test can further comprise outputting to the user device one or more times throughout the targeted advertisement(s) a test answer message and a list of answer choices. The test answer message can comprise a single distorted letter or digit that appears at a random location at random time intervals, while the list of answer choices can comprise multiple letter or digit choices including the test answer message. In various embodiments, the test answer message can comprise a single undistorted letter or digit that appears at a random location at random time intervals, while the list of answer choices can comprise multiple distorted letter or digit choices including the test answer message. Embodiments can further comprise verifying that the user selects the matching letter or digit from the list of answer choices for each test answer message occurrence on the first attempt and within an allotted time period. Embodiments can further comprise outputting to the user device one or more times before or after playback of the at least one targeted advertisement (for example, between commercial segments) an audio test answer message and a list of answer choices. The audio test answer message can comprise a single spoken letter or digit. The list of answer choices can comprise multiple distorted letter or digit choices including the audio test answer message. Embodiments can further comprise verifying that the user selects the matching letter or digit from the list of answer choices for each audio test answer message occurrence on the first attempt and within an allotted time period.

In various embodiments, allowing playback can further comprise receiving a license key if both the content of the user responses to the interactive viewer test(s) and the order in which the user responses are received are determined to be correct. In such embodiments, playback of the digital content is allowed in response to receiving the license key.

Various embodiments can also comprise providing the user the capability to use, view, or play the digital content on more than one user device in exchange for viewing additional amounts of targeted advertisements.

Alternatively, the digital content can comprise non-downloadable digital content. In such embodiments, the targeted advertisement(s) can be provided together with the non-downloadable digital content. Playback of the targeted advertisement(s) can occur before, during, or after playback of the non-downloadable digital content. Furthermore, the amount of the non-downloadable digital content allowed to be played at the user device can be based on the number of targeted advertisements viewed.

These and other features of the present teachings are set forth herein.

It is to be understood that both the foregoing general description and the following detailed description are exemplary and explanatory only and are intended to provide a further explanation of the present teachings, as claimed.

### BRIEF DESCRIPTION OF THE DRAWINGS

The utility, objects, features and advantages of the invention will be readily appreciated and understood from consideration of the following detailed description of the embodiments of this invention, when taken with the accompanying drawings, in which same numbered elements are identical and:

FIG. 1 is a top level system block diagram of a content access system according to various embodiments;

FIG. 2 is a top-level flow chart of a method according to various embodiments;

FIG. 3 is a flow chart of a content access method according to various embodiments;

FIGS. 4a through 4c show a detailed method according to various embodiments;

FIG. 5 is a data and control flow diagram of a license key acquisition method according to various embodiments;

FIGS. 6a through 6d are examples of interactive content selection pages according to various embodiments;

FIGS. 7a through 7c are examples of category selection interactive pages according to various embodiments;

FIG. 8 is timing diagram of a commercial broadcasting method according to various embodiments

FIGS. 9a through 9c shown a first example interactive viewer test in accordance with various embodiments;

FIGS. 9d and 9e shown a second example interactive viewer test in accordance with various embodiments;

FIGS. 10a through 10c are example advertisement pages in accordance with various embodiments;

FIG. 11 is an example ad cart selection page according to various embodiments;

FIG. 12 is a flow chart of a license key generation method according to various embodiments; and

FIG. 13 is a schematic block diagram of a computing device according to various embodiments.

### DETAILED DESCRIPTION

Various embodiments can comprise systems and methods for providing access to digital content. For example, various embodiments can comprise providing digital content to a user device, providing at least one targeted advertisement to the user device in which the targeted advertisement(s) comprise files that are separate from the digital content, and outputting one or more interactive viewer tests to the user device during playback of the targeted advertisement(s). The interactive viewer test can comprise at least one question designed to solicit human user input. Further, the question(s) can be contextually unrelated to the content of the targeted advertisement(s). Various embodiments can comprise providing a license key to allow playback of the digital content by the user device upon successful validation of the user responses and the order in which the user responses are received.

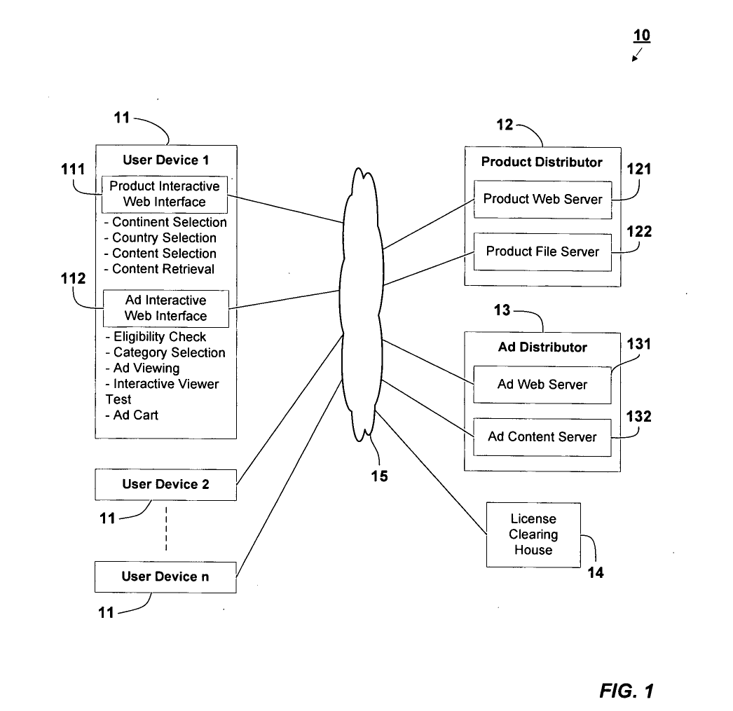

FIG. 1 is a top level system block diagram showing a content access system 10 according to at least one embodiment. Referring to FIG. 1, in various embodiments the content access system 10 can comprise one or more user devices 11, at least one product distributor 12, at least one advertisement (ad) distributor 13, and a license clearing house 14. In various embodiments, the user device(s) 11, product distributor 12, ad distributor 13, and license clearing house 14 can be provided in communication using a network 15. In various embodiments, the product distributor 12 and the ad distributor 13 can be hosted by the same computing platform or by separate ones.

In various embodiments, the user device 11 can comprise a product interactive web interface 111 and an ad interactive web interface 112. Further, the product distributor 12 can comprise a product web server 121 and a product file server 122. In addition, the ad distributor 13 can comprise an ad web server 131 and an ad content server 132. In various embodiments, the product interactive web interface 111 can be configured to perform continent selection, country selection, content selection, and content retrieval in conjunction with the product web server 121 and product file server 122 as described herein. Further, the ad interactive web interface 112 can be configured to perform an eligibility check, category selection, ad viewing, and at least one interactive viewer test in conjunction with the ad web server 131 and ad content server 132 as described herein. In various embodiments, the ad interactive web interface 112 can comprise an ad cart. In various embodiments, each of the server sub-processes 121, 122, 131, and 132 can be hosted by separate servers. Alternatively, each of the server sub-processes 121, 122, 131, and 132 can be hosted by the same server, or any combination in between.

As shown in FIG. 1, in various embodiments the servers 121, 122, 131, and 132 can be configured to communicate with one or more user devices 11 using the network 15. The product distributor 12 can comprise at least one product web server 121 and at least one product file server 122. The ad distributor 13 can comprise at least one ad web server 131 and at least one ad content server 132. In various embodiments, the product distributor 12 and ad distributor 13 can comprise one or more physical locations that use or are provided with the content access system 10. The product distributor 12 can include digital content from multiple product sources (for example, Sony Music). The ad distributor 13 can include advertisements and commercial segments from multiple ad sources. Although for illustrative purposes only one each of the servers 121, 122, 131, and 132, and license clearing house 14 are shown in FIG. 1, it is to be understood that more than one of any of the servers 121, 122, 131, and 132, or license clearing house 14 can be provided in communication using one or more networks such as the network 15 as shown in FIG. 1.

In various embodiments, the product interactive web interface 111 and ad interactive web interface 112 and the servers 121, 122, 131, and 132 can be configured, for example, by a sequence of programmed instructions, to provide digital content to a requesting user device 11, provide targeted advertisement(s) to the requesting user device 11, and output interactive viewer test(s) to the user device 11 during playback of the targeted advertisement(s). In various embodiments, the targeted advertisements can comprise files that are separate from the digital content files. The interactive viewer test can comprise at least one question designed to solicit human user input. In various embodiments, the question(s) can be contextually unrelated to the content of the targeted advertisement(s). In various embodiments, user device 11 can playback the digital content upon receiving a corresponding license key from the license clearing house 14 after successful validation of the user responses and the order in which the user responses are received for the interactive viewer test(s) from the user device 11.

The user device 11 can comprise a PC such as a PC workstation, desktop, mobile PC or laptop PC, or a tablet PC, a PDA, a cellular telephone, a Blackberry™ device, a pager, a Wi-Fi device, a Bluetooth™ enabled device, a set top box or Tivo™ device, a Microsoft® Media Center device, a radio receiver, a wireless handset, or other such browser-enabled device, or a portable player such as, for example, an MP3 player. In various embodiments, the user device 11 can be capable of communicating with the servers 121, 122, 131, 132, and the license clearing house 14 using the network 15.

In various embodiments, the product web server 121 and product file server 122 can provide digital content to the user device 11 via the network 15. In various embodiments, the product interactive web interface 111 can be configured to interact with the product web server 121 to provide the user device 11 with one or more links to selected products. In various embodiments, the product links can comprise hypertext links in accordance with the HyperText Markup Language (HTML) and HyperText Transfer Protocol (HTTP). Each HTTP link can be associated with a Uniform Resource Locator (URL) for a particular item of digital content. The links tell the user device 11 where to get the specific product they're looking for from the product file server 122. Thus, using the product interactive web interface 111, the user device 11 can select products and with the links provided on the product interactive web interface 111, the user device 11 can get to the correct location on the product file server 122 and retrieve the product (for example, an item of digital content).

In various embodiments, the ad web server 131 and ad content server 132 can provide targeted advertisements or commercial segments in digital form to the user device 11 via the network 15. In various embodiments, the ad interactive web interface 112 can be configured to interact with the ad content server 132 to solicit category selections and output targeted advertisements based on the categories selected to the user device 11. Furthermore, the ad interactive web interface 112 can be configured to interact with the ad web server 131 to perform an eligibility check and determine if the user device 11 is located in a country for which targeted advertisements are available. In various embodiments, the ad web server 131 can also administer at least one interactive viewer test during the targeted advertisement viewing to the ad interactive web interface 112 on the user device 11.

In various embodiments, the license clearing house 14 can provide license keys to the user device 11 via the network 15. In various embodiments, the ad interactive web interface 112 can be configured to interact with the ad web server 131 and the license clearing house 14 to provide the user device 11 with the license key to activate the digital content. The license clearing house 14 can comprise a server configured to generate license keys in response to receiving a request from the user device 11. In various embodiments, the license clearing house 14 can be a third-party company that generates a license key for a fee. In various embodiments, the ad web server 131 requests a pass code from the license clearing house 14 and administers the interactive viewer test(s) based on the pass code received. Upon successful completion of the interactive viewer test(s), the user device 11 will be in possession of the pass code. In various embodiments, the user device 11 can then contact the license clearing house 14 directly and provide the pass code for authentication. In various embodiments, once the pass code has been authenticated, the license clearing house can generate the corresponding license key for the digital content. Upon receiving the license key, the user device 11 can decrypt and view, play, or playback the associated digital content.

In various embodiments, the network 15 can comprise a packet-switched network. For example, the network 15 can comprise a Transmission Control Protocol/internet Protocol (TCP/IP) network. In various embodiments, the network 15 can comprise a public network such as, for example, the Internet. Alternatively, the network 15 can comprise, without limitation, a telephone landline based modem or a wireless network such as a cellular digital packet data (CDPD) network or a wireless local area network (WLAN) provided in accordance with, for example, the IEEE 802.11 standard, Global System for Mobile communications (GSM) Generalized Packet Radio Service (GPRS) and variations thereof, an optical communications network, or other such communications network capable of transporting packet-based information. Other networks may also be used. In various embodiments, the servers 121, 122, 131, and 132 can be capable of communication with the user device(s) 11, and the license clearing house 14 using the network 15.

In various embodiments, the product web server 121 and the ad web server 131 can be configured to generate and transmit product and advertisement information in the form of interactive HTML pages to the user device 11 via the network 15. The product web server 121 can receive requests for user selections such as continent selection and country selection. The product file server 122 can receive requests for digital content selection. The ad web server 131 can receive test responses. The ad content server 132 can receive category selections. In various embodiments, the user provided information may be received in the form of user entered data contained in an interactive HTML page or an HTML hyperlink provided in accordance with the Java Server Pages™ standard developed by Sun™ Microsystems. Alternatively, user provided information can be received in the form of user entered data contained in an interactive HTML page provided in accordance with the Active Server Pages (ASP) standard. In response to a user entered request, the product web server 121 or the ad web server 131 can output the requested information as an interactive HTML page. The product web server 121, ad web server 131, and ad content server 132 can obtain data corresponding to the user request using a corresponding command to retrieve the data from a database or data storage device requesting retrieval of the associated page data. The database or data storage device can, in various embodiments, then execute one or more scripts to obtain the desired information and provide the retrieved data to the requesting module. Upon receipt of the requested data, the product web server 121 and the ad web server 131 can build an interactive HTML page including the requested data and transmit the page to the requesting user device 11 in accordance with, for example, XML and Java Server Pages™ (JSP) formatting standards. In various embodiments, the database or data storage device does not maintain or store personal information or profile information for users.

In various embodiments, the ad web server 131 can also be configured to provide administrative functions for the system 10 such as, for example, defining an access level for users of the system 10. For example, various access levels or permissions can be provided. For example, one access level may permit a user digital content access privileges only. Another access level can permit a supervisory user to add, modify, or delete links to digital content or advertisements.

The user device 11 can comprise a browser application for downloading, uploading, or receiving information or data using the network 15. In various embodiments, the user device 11 and the servers 121, 122, 131, and 132 can comprise a sequence of programmed instructions that when executed by a processor, such as a PC, cause the processor to be configured to perform functions as described herein. For example, in an embodiment, product interactive web interface 111 and the ad interactive web interface 112 of the user device 11 can comprise one or more Java™ scripts that include a sequence of Java™ instructions. The script or instructions can be executed by the browser application to perform the functions described herein.

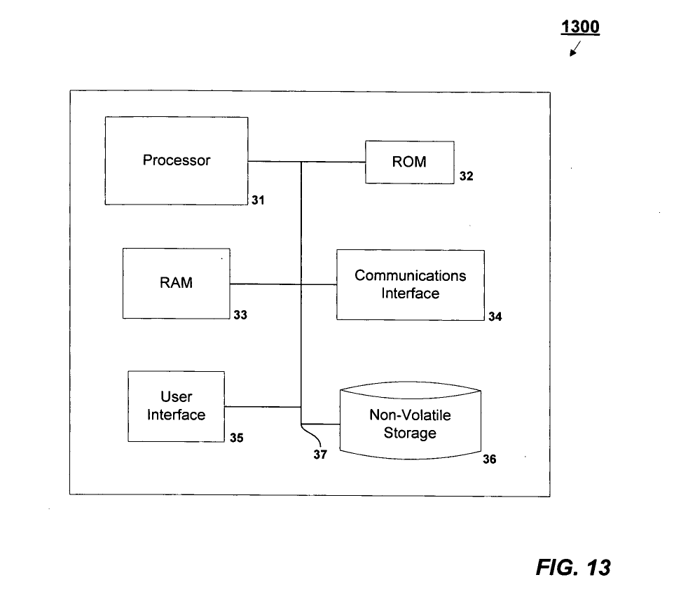

The servers 121, 122, 131, or 132 can also comprise a database or data storage device for storing data and content as well as information received from the user device 11. The data storage device can be, for example, a hard disk or other non-volatile storage device internal to a PC such as the non-volatile storage device 36 shown in FIG. 13. Alternatively, the database or data storage device can comprise a hard disk or other storage device connected to and accessible by a PC using a LAN or cable. The user device 11 and servers 121, 122, 131, and 132 can also include various applications such as, for example, an electronic mail application for receiving electronic mail messages in accordance with, for example, the Post Office Protocol (POP/POP3).

The user device 11 browser application can be capable of transmitting and receiving and displaying HyperText Markup Language (HTML) information in accordance with the HyperText Transfer Protocol (HTTP) using the network 15. For example, the user device 11 can include the Netscape Navigator™ browser application available from the Netscape Corporation of Mountain View, Calif. Other browser applications may be used, including without limitation, Microsoft Internet Explorer™. In at least one embodiment, the user device 11 can comprise, for example, a web-enabled PC provided with the capability to receive and display graphical user interfaces included on, for example, HyperText Markup Language (HTML) formatted or Extensible HyperText Markup Language (XML) formatted pages, private network (e.g., intranet) pages, etc., provided in accordance with, for example, HyperText Transport Protocol (HTTP) as well as the capability to transmit and receive electronic mail messages in accordance with Simple Mail Transport Protocol (SMTP) and files in accordance with the File Transfer Protocol (FTP). Thus, an embodiment of the user device 11 can include a PC having a network connection or interface, such as a dial-up modem or Digital Subscriber Line (DSL) connection to a network. In operation, a user may cause the user device 11 to request digital content (or to conduct other operations for an administrative user) from the servers 121, 122, 131, or 132.

In various embodiments, the user device 11 can further comprise an application configured to play or playback the digital content at the user device 11. For example, the user device 11 can comprise the Windows™ Media Player™ available from Microsoft Corporation.

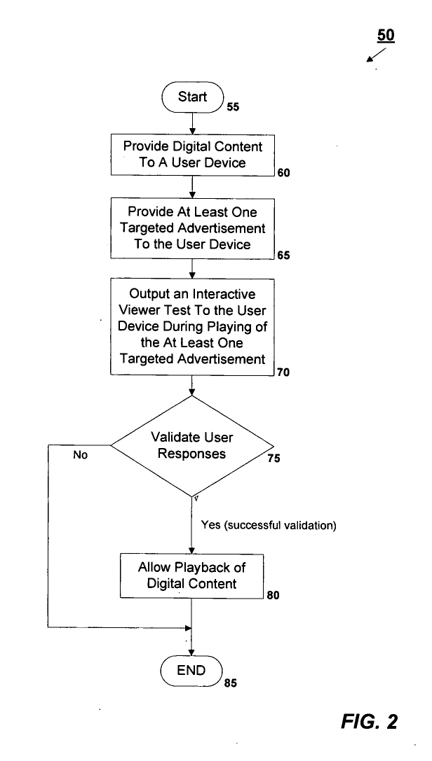

Various embodiments can comprise systems and methods for providing access to digital content. With respect to FIG. 2, there is shown a top-level flow chart of a method 50 according to various embodiments. Various embodiments can comprise providing a license to a user to view or playback one or more items of digital media or digital content in exchange for viewing online advertisements. Digital media or content can comprise, for example, but not limited to, music, video, electronic text/books, and software. For example, digital content can comprise Windows™ Media Audio (WMA) files. In various embodiments, the digital content can be provided for anyone to download, but access thereto can be restricted using a Digital Rights Management (DRM) regime in which license keys are required to open unlicensed digital content. DRM refers to any of several technical methods used to control or restrict the use of digital media content on electronic devices with such technologies installed. For example, DRM can comprise a Microsoft® software product to protect Windows™ Media Audio (WMA) files.

As shown in FIG. 2, the method 50 can commence at 55. The method can proceed to 60, which can comprise providing digital content to a user device 11. The method can then proceed to 65, which can comprise providing at least one targeted advertisement to the user device 11. In various embodiments, the at least one targeted advertisement can comprise one or more files that are separate from the digital content. The method can then proceed to 70, which can comprise outputting at least one interactive viewer test to the user device 11 during playback of the at least one targeted advertisement. In various embodiments, the interactive viewer test can comprise at least one question prompting user responses. The question(s) can be contextually unrelated to the content of the targeted advertisement(s). The method can then proceed to 75, which can comprise validating that the user response to each interactive viewer test is correct. If so, then the method can proceed to 80 to obtain a license key to allow playback of the digital content by the user device 11 upon successful validation of the user responses to the interactive viewer test(s). If validation is unsuccessful, then the method may end, at 85. Following playback of the digital content at 80, the method can then proceed to 85, at which the method may end.

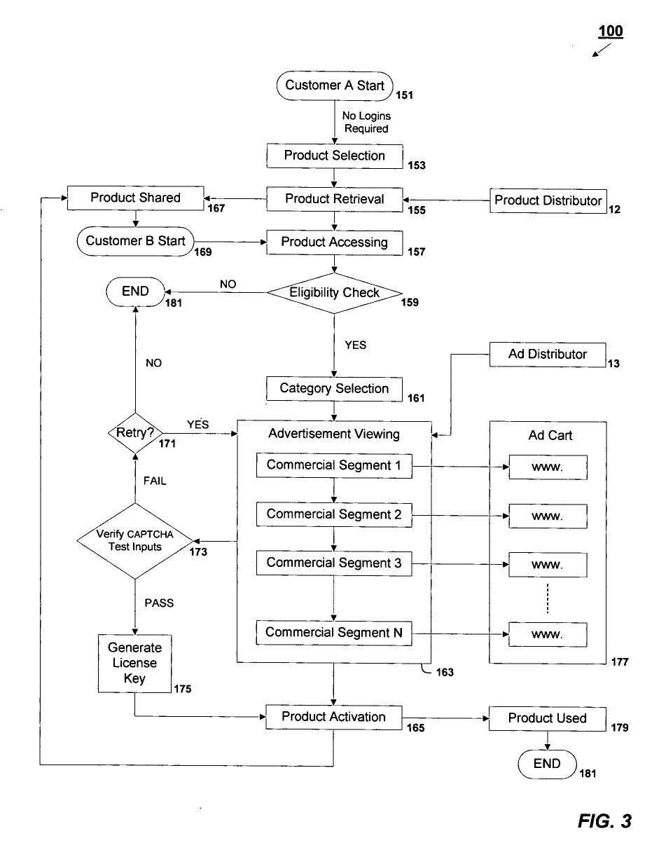

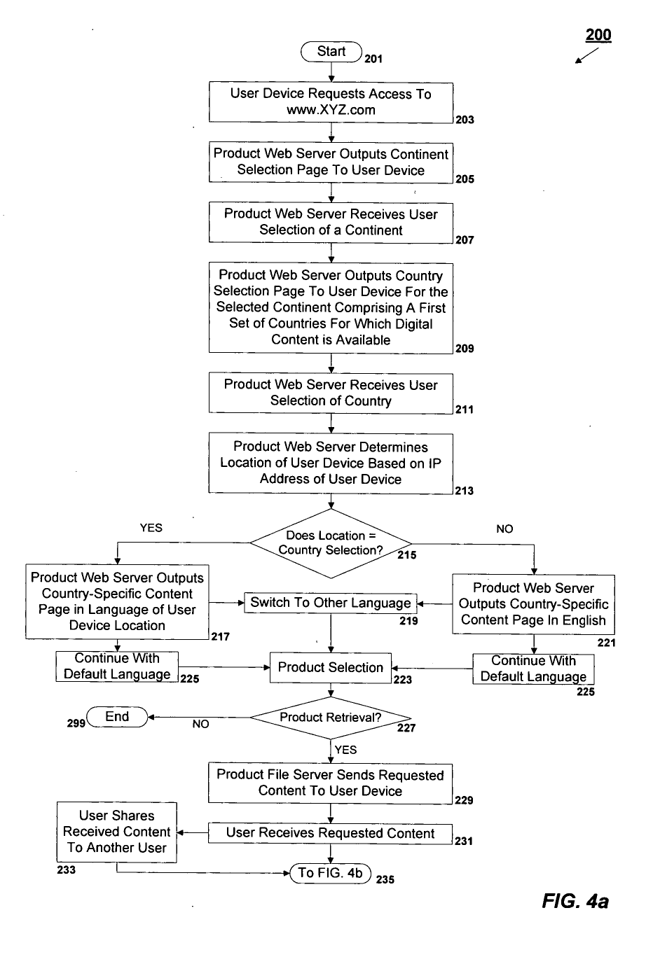

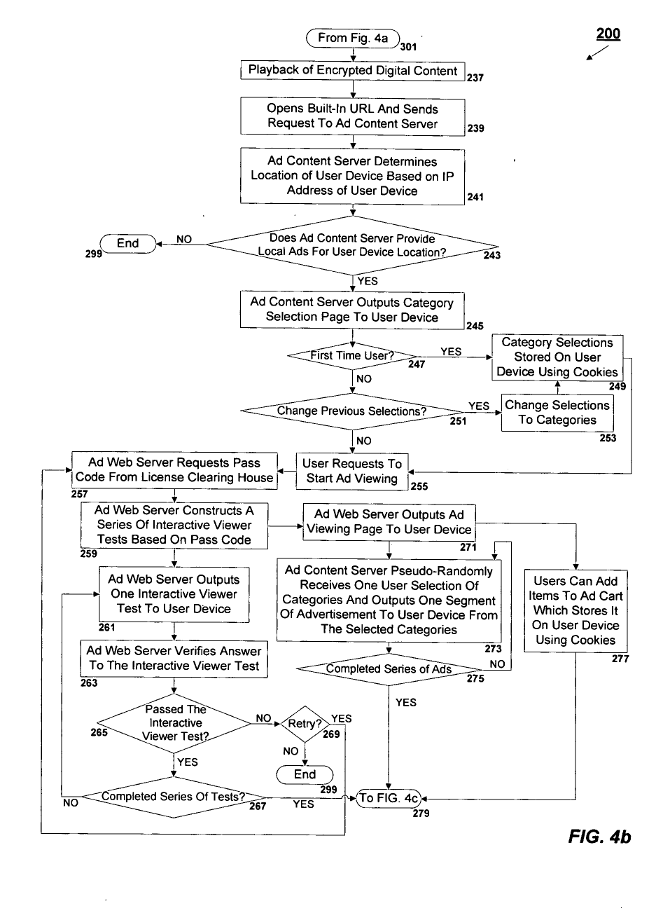

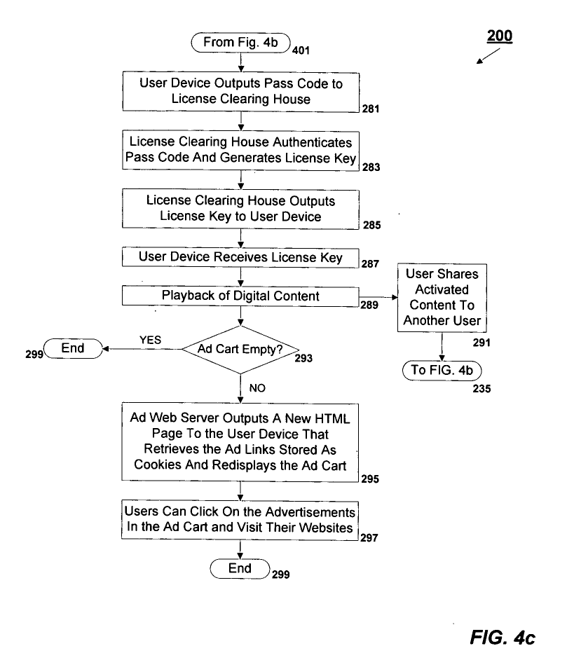

With respect to FIG. 3, there is shown a flow chart of a content access method 100 according to various embodiments. Further aspects of the method 100 are shown in the detailed flow chart of FIGS. 4a through 4c. As shown in FIG. 3, a method 100 may commence at 151 and proceed to product selection at 153, at which the method can comprise outputting and receiving various content selection pages to and from a user device 11 to accomplish continent selection, country selection, and country-specific digital content selection. As shown in FIG. 3, a first time visitor (for example, Customer A) to a WWW site or website associated with the content access system 10, which can comprise an online store, can browse through the entire catalog of available digital content items and retrieve or obtain any contents from the catalog of available items. The contents can be received, for example, via file download using the network 15. In various embodiments, customers do not need to sign up for accounts or exchange money or services for downloading digital content items. As described herein, to view, play, or playback the digital content, however, requires licensing keys that are supplied only upon completion of the viewing of targeted advertisement(s).

Following product selection at 153, the method can proceed to 155 for product retrieval. Products (for example, digital content) can be received from the product file server 122 of the product distributor 12. The product file server 122 can store products originated from one source or multiple sources. For example, the product file server 122 can store music files exclusively from Sony Music, or it can store music files from multiple record companies, or it can store any digital content ranging from music to videos, to software etc. In various embodiments, the digital content cannot be viewed or played or played back at the user device 11 until receiving the license key. The digital content can also be shared to another user (Customer B) at 167, who, when accessing the digital content, will be required to view a new set of targeted advertisement(s) to acquire a new licensing key, starting at 169. In various embodiments, sharing of digital content can comprise using email services, instant messaging services, file transfer services such as www.yousendit.com, File Transfer Protocol (FTP), or any super distribution, such as BitTorrent or any P2P sharing services. In various embodiments, providing digital content can comprise downloading a digital file to the user device 11 in response to a request for the file received from the user device 11. Furthermore, the number of user devices for which the digital content can be viewed, played, or played back on can be based on the number of targeted advertisements viewed. Alternatively, the digital content can comprise non-downloadable digital content. In such embodiments, the targeted advertisement(s) can be provided together with the non-downloadable digital content. Playback of the targeted advertisement(s) can occur before, during, or after playback of the non-downloadable digital content. Furthermore, the amount of the non-downloadable digital content allowed to be played at the user device 11 can be based on the number of targeted advertisements viewed.

In various embodiments, the digital content items can be available for everyone to receive or download. However, since targeted advertisements, namely commercials, are in general local to each country, only users residing in countries for which we provide local targeted advertisements for, can view the required targeted advertisements and subsequently obtain the licensing keys to activate the digital contents. In various embodiments, this is accomplished by maintaining a first set of countries for which digital content is available and a second set of countries for which local targeted advertisements are available. Therefore, any users can retrieve digital content from the first set of countries, but only users residing in the second set of countries are allowed to view targeted advertisements and subsequently acquire the license key. It is also to be understood that in most cases the second set of countries include the first set of countries.

As shown in FIG. 3, after product retrieval at 155 the method can proceed to product accessing at 157. At 157, the method can commence steps required to obtain the license key(s) to permit use, viewing, playing, or playback of the products as discussed below. In various embodiments, users can be required to pass the eligibility check, select categories, and view targeted advertisement(s) based on the categories selected. Furthermore, various embodiments can comprise passing one or more interactive viewer tests before acquiring the licensing key.

As shown in FIG. 3, after product accessing at 155 the method can proceed to an eligibility check at 159. In various embodiments, the eligibility check can comprise determining the users' locations and whether or not the user is allowed to proceed with the viewing of targeted advertisements. According to various embodiments, anyone with Internet access can download music from any of the “x” music sites comprising the first set of countries. However, only users residing in the second set of “y” countries will have local targeted advertisements to watch and licensing keys to obtain. For example, the first set of countries, “x,” for which digital content is available can comprise the ten countries USA, UK, France, Mexico, Russia, Japan, South Korea, China, India, and Taiwan. Further, a second set of countries, “y,” can be provided for which local targeted advertisements are available. The second set of countries can be, for example, the union of the first set of countries and a number of additional countries for which local targeted advertisements are available such as, for example, Canada, Germany, Singapore, Malaysia, and Italy, making fifteen total countries in the second set of countries, in this example. In various embodiments, eligible users can be allowed to proceed to category selection at 161 whereas for ineligible users, the method may end at 181.

For eligible users, as shown in FIG. 3, after eligibility check at 159 the method can proceed to category selection at 161 for the targeted advertisements. After obtaining the digital content, various embodiments can comprise receiving category selections from the user device 11, and sending targeted advertisements to the user device 11 based on the received category selections. In various embodiments, the ad content server 132 can be capable of communication with the user device 11 for outputting interactive pages to the user device 11 and for receiving user selections input from the user device 11. For example, in various embodiments, the ad content server 132 can output category selection pages to the user device 11. The ad content server 132 can output digitized targeted advertisements or commercial segments to the user device 11, and the user device 11 can be capable of receiving digitized targeted advertisement or commercial segments from the ad content server 132. In various embodiments, the ad web server 131 and ad content server 132 can be provided in communication with a database or data storage device.

Once the preferred categories have been chosen at 161, the method can then proceed to targeted advertisement viewing at 163, which can comprise the viewing of one or more targeted advertisements (for example, one or more commercial segments). As shown in FIG. 3, up to “n” commercial segments can be included in the advertisement viewing. During the targeted advertisement viewing, the ad web server 131 can output one or more interactive viewer tests to the user via the ad interactive web interface 112 on user device 11. The interactive viewer test can be designed to verify that the user has viewed the targeted advertisements. In various embodiments, the interactive viewer test can comprise at least one question that is unrelated to the content of the targeted advertisements.

The method can then proceed to verifying interactive viewer test inputs at 173. Following successful validation of the interactive viewer test(s), the method can then proceed to generate the license key at 175. In various embodiments, the license key can be generated by the license clearing house 14. Following unsuccessful validation of the interactive viewer test(s), the method can proceed to ask the user to retry at 171. The user can either restart the targeted advertisement viewing at 163 or the method may end at 181.

As shown in FIG. 3, the method can then proceed to product activation at 165 using the license key obtained from the license clearing house 14. The method can then proceed to product use at 179 or the product can be shared to another user (Customer B) at 167 who, when accessing the digital content, will be required to view a new set of targeted advertisements to acquire a new licensing key, starting at 169. As described earlier, in various embodiments, sharing of digital content can comprise using email services, instant messaging services, file transfer services such as www.yousendit.com, File Transfer Protocol (FTP), or any super distribution, such as BitTorrent or any P2P sharing services.

Furthermore, as shown in FIG. 3, during targeted advertisement viewing at 163, contextually related advertisement links can be displayed and accumulated by user selection and viewed using the Advertisement (“Ad”) cart at 177. Upon completing the targeted advertisement viewing, the user can select advertisement links in the ad cart to view.

Following product use at 179, the method can then proceed to 181, at which the method can end.

With respect to FIGS. 4a through 4c, there is shown a detailed method 200 according to various embodiments. As shown in FIG. 4a, the method 200 can commence at 201 and proceed to 203. At 203, the user device 11 can request access to the content access system 10. For example, the user can enter a URL associated with the content access system 10 (for example, www.XYZ.com) into a browser application.

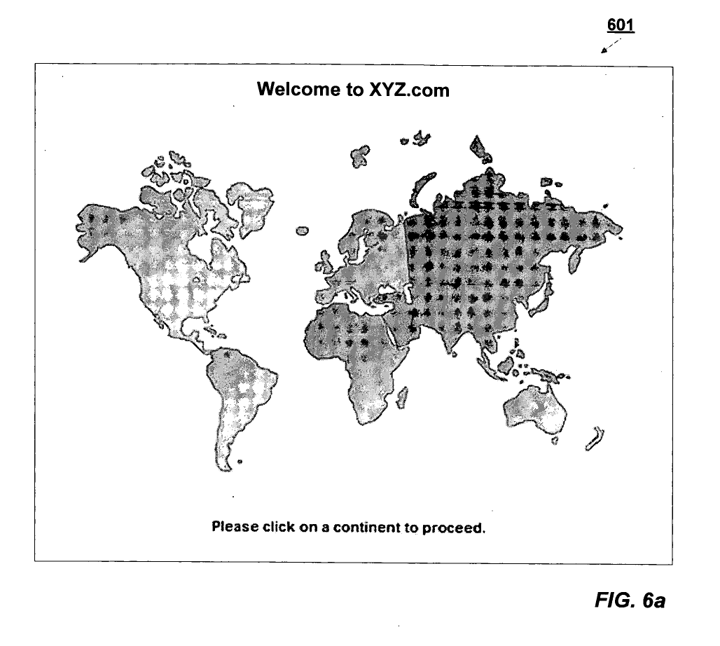

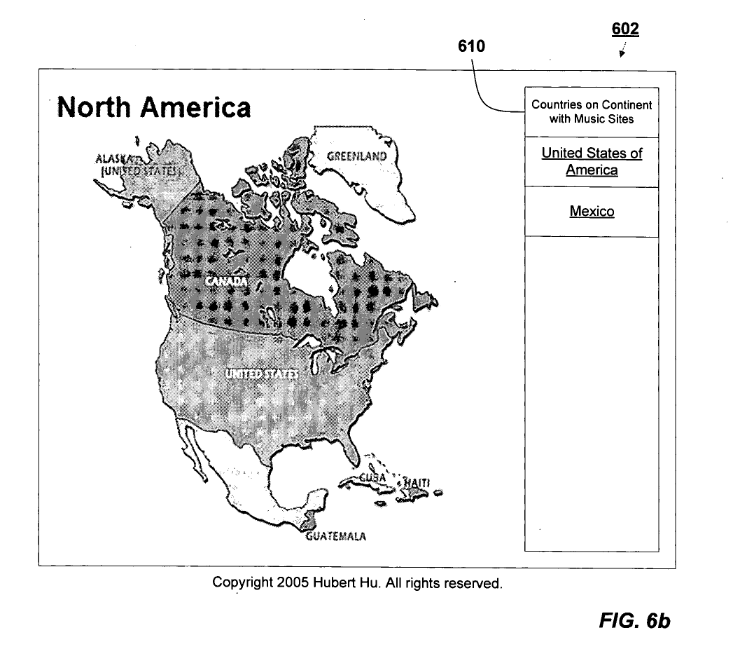

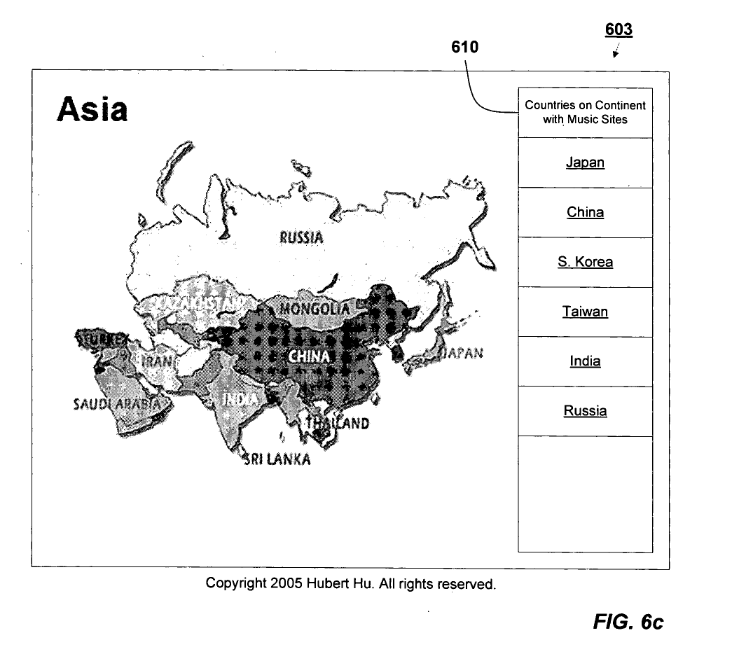

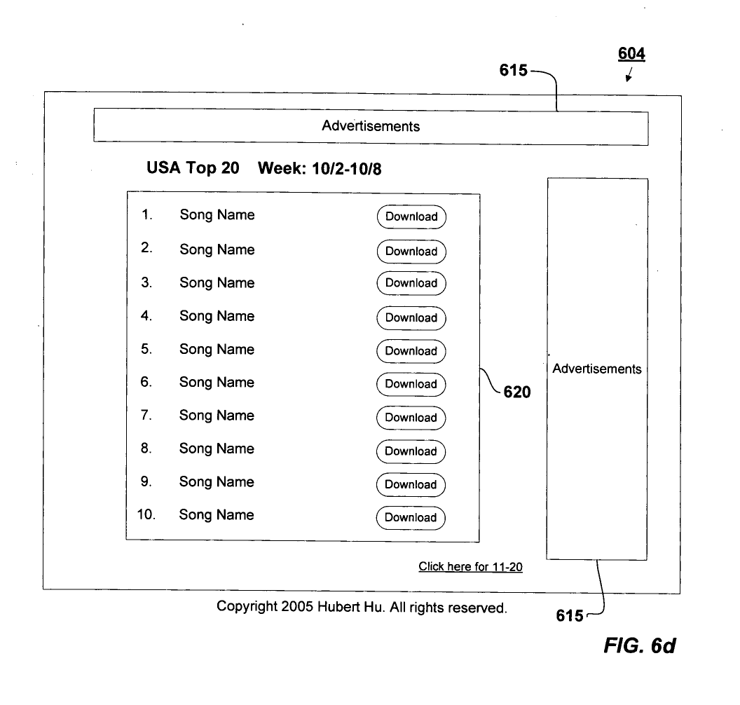

The method 200 can then proceed to 205, at which the product web server 121 can output a continent selection page to the user device 11. In various embodiments, the product web server 121, ad web server 131, and the ad content server 132 can output interactive content selection pages to the user device 11. With respect to FIG. 6a, there is shown an example top-level interactive continent selection page 601 output by the product web server 121 according to various embodiments. As shown in FIG. 6a, the top-level interactive content selection page 601 can comprise, for example, a global view of the Earth's continents. The user can be prompted to select, using a pointing and selection device such as a mouse device, for example, a continent for which the user can further select different countries' music sites from which the user can further select and obtain specific digital content. For example, in various embodiments, as user moves a cursor over the continents, an indication can be provided on the continent selection page 601 that the continent is selectable. The indication can be a popup menu or a highlighted link, for example. In various alternative embodiments, as the user moves a cursor over the continents, a popup window listing the countries for which content is available can be output to the display of the user device 11. An example of a website having world map is available at www.emporis.com/en/wm/.

The method 200 can then proceed to 207, at which the product web server 121 can receive the user continent selection. In particular, in various embodiments, upon user selection of a continent, the user device 11 can send the continent selection message to the product web server 121 via the network 15. For example, the continent selection message can comprise an HTML-formatted continent identifier.

The method 200 can then proceed to 209, at which the product web server 121, upon receiving the continent selection from the user, can output to the browser application of the user device 11 a country selection page associated with the selected continent for display at the user device 11. With respect to FIGS. 6b and 6c, there are shown example interactive country selection pages 602 and 603 for North America and Asia continent selections, respectively. Country selection pages for other continents can be provided also. As shown in FIGS. 6b and 6c, the HTML-formatted interactive country selection pages 602 and 603 can comprise, for example, a first set of countries 610 for which digital content is available.

The method 200 can then proceed to 211, at which the product web server 121 can receive the user country selections from the user device 11 indicating one or more countries from the first set of countries 610. Furthermore, various embodiments can comprise outputting a country-specific content page to the user device 11 for a selected country.

The method 200 can then proceed to 213, at which product web server 121 can determine the location of the user device. This can be accomplished, for example, by determining location based on the IP address of the user device. For example, the location of a user device 11 can be determined by the location associated with the user device 11 IP address obtained from a list of locations and associated IP addresses. The list can be obtained from a third party provider. The list of IP addresses and their associated locations can be stored using the data storage device 36. In various embodiments, the country-specific content page can be provided to the user device in either the English language or the native language based on the location of the user device 11.

The method 200 can then proceed to 215, at which the method 200 can determine, based on the user device location determined at 213, whether or not the user device location is the same as the country selected at 211. If so, the method 200 can proceed to 217. If not, the method 200 can proceed to 221. With respect to FIG. 6d, there is shown an example country-specific content page 604 comprising links 620 to country-specific digital content and static advertisements 615. From the country-specific content page 604, the user can select country-specific digital content using one of the links or buttons 620. In various embodiments, the country-specific digital content can comprise a number of files. On the country-specific content page 604, an HTML link can be associated with each one of the files. For illustrative purposes, the country-specific content page 604 of FIG. 6d is shown in the English language; however, it is to be understood that the country-specific content page 604 can be output in a different language depending on the user location.

At 217, the product web server 121 can output the country-specific content page in the language of the user device location. The method can then proceed to 225, at which the user can choose to continue in the default language, or the method can proceed to 219, at which the user can switch to another language.

At 221, the product web server 121 can output the country-specific content page in the English language. The method can then proceed to 225, at which the user can choose to continue in the default language, or the method can proceed to 219, at which the user can switch to another language.

From 225 or 219, the method 200 can then proceed to 223. At 223, the user can accomplish product selection of digital content at the user device. In various embodiments, digital content can be selected for output by the product web server 121 according to different criteria. For example, the digital content links 620 output using the country-specific content page 604 shown in FIG. 6d can comprise the current top “x” (for example, x=20) songs for a country. Alternatively, one or more other criteria can be used. For example, digital content can be output based on a top song listing or ranking from a previous time period, or based on genre. Furthermore, alternatively, the user can select digital content from a huge catalog of content such as, for example, a song catalog. In addition, digital content can be ranked according to various criteria. Further, in various embodiments, users can also vote on their favorites. The product file server 122 can comprise a catalog of many items of content indexed by, for example, song/file links. Types of content files can comprise, for example, but not limited to, JPEG, .jpg, .wav, .bmp, .mp3 files.

Upon browsing through the products on the country-specific content page, the method 200 can proceed to 227. At 227, the user can decide whether or not to retrieve the selected product(s). If the user wants to proceed, then the method 200 can proceed to 229. If not, the method 200 can end at 299.

At 229, the product file server 122 can send the requested digital content to the user device 11. The method 200 can then proceed to 231, at which the user device 11 can receive from the product file server 122 the particular items of selected digital content. In various embodiments, the product file server 122 can be capable of communication with the user device 11 for outputting digital content to the user device 11 (and for receiving user selections input from the user device 11). The product file server 122 can maintain digital content obtained from one or more product sources and provide the requested digital content to the user device 11. For example, the user can be prompted on the country-specific content page 604 to select, using a pointing and selection device such as a mouse device, for example, to select and retrieve one or more items of digital content 620 that the user would like to obtain and playback at the user device 11. Upon user selection of the digital content item(s) 620, the user device 11 can send a content selection message to the product file server 122 via the network 15. For example, the content selection message can comprise an HTML-formatted content identifier. Upon receiving the content selection message(s) with the content identifier(s), the product file server 122 can output or send to the user device 11 the digital content item requested. The product file server 122 can store the items of digital content. In various embodiments, the product file server 122 can download the item of digital content to the user device via File Transfer Protocol (FTP), or may stream the digital content to the user device 11.

The method 200 can then proceed, optionally, to 233, at which the user can elect to share received content to another user.

As shown in FIG. 4b, the method 200 can then proceed to 237. At 237, the user can attempt to playback the received digital content. However, in various embodiments, the digital content cannot be viewed or played or played back at the user device 11 until receiving a license key, as described further herein. Thus, selected products can be downloaded, but not yet activated. In various embodiments, when a file is opened using an application at the user device 11 such as, for example, the Windows™ Media Player™, the user application can bring up an interactive web interface to proceed with the license acquisition process. However, in various embodiments, for example the “Play” button of the media player is inoperative until license key received.

In various embodiments, upon the user attempting to playback digital content, the method 200 can proceed to 239. At 239, the user device 11 can open a built-in URL stored in the digital content and send a request for category selection to the ad content server 132.

The method 200 can then proceed to 241, at which the ad content server 132 can determine the location of the user device 11. In various embodiments, the ad content server 132 can determine the targeted advertisements to be provided to the user device 11 based on the location of the user device 11. Location can be determined, for example, based on the user device 11 Internet Protocol (IP) address.

The method 200 can then proceed to 243, at which the ad content server 132 can perform an eligibility check to determine whether or not the user can receive digitized targeted advertisements. In various embodiments, eligibility can be based on location of the user device 11. In various embodiments, only users whose user device 11 has a location (for example, IP address) comprising one of the countries in a second set of countries for which targeted advertisements are provided can receive digitized targeted advertisements. Because only users who successfully pass the interactive viewer test during the targeted advertisement viewing can receive a license key to view or playback the digital content item(s) received at the user device 11, in various embodiments, only users whose user devices 11 are located in one of the countries in the second set of countries for which targeted advertisements are available can access the digital content for viewing or playback. However, it should be noted that the digital content can be received (for example, streamed or downloaded) at any user device 11 regardless of location. Thus, if the ad content server 132 provides local targeted advertisements for the user device 11 location, the method can proceed to 245. If not, the method 200 can end at 299.

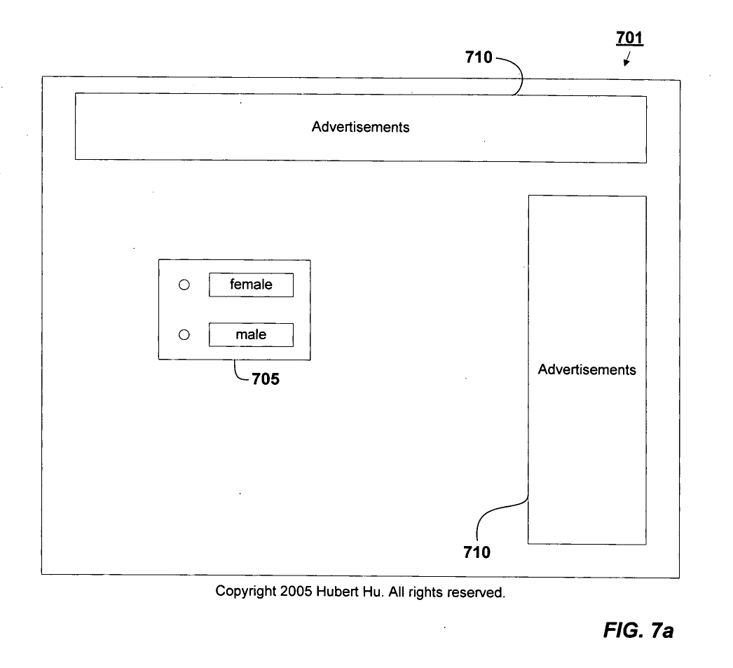

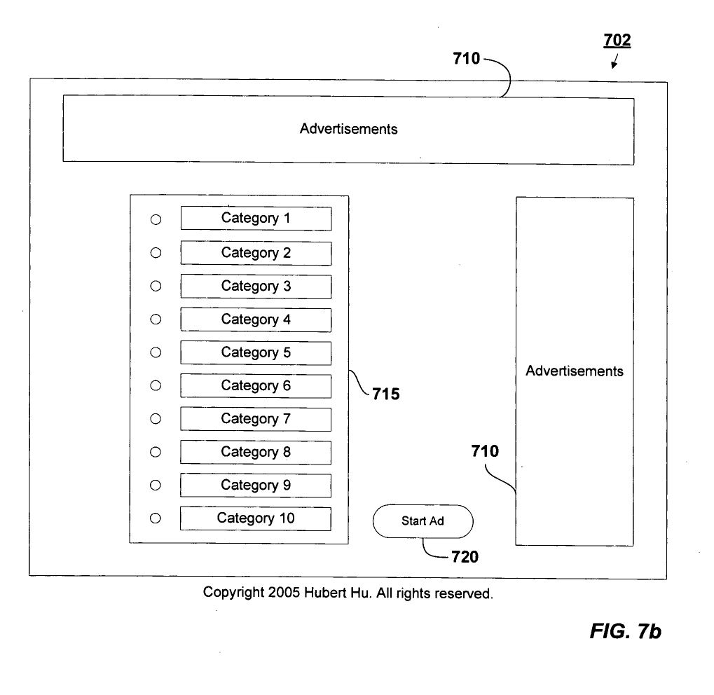

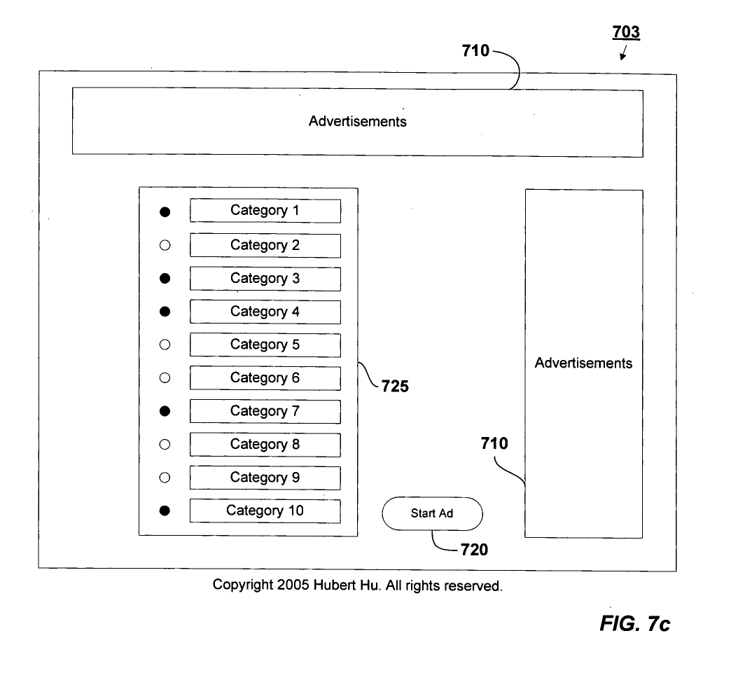

At 245, for eligible users, the ad content server 132 can output category selection page(s) to the user device 11. In various embodiments, the ad content server 132 can be configured to receive one or more types of category selections. First, the ad content server 132 can output a first interactive category selection page to the user device 11. With respect to FIG. 7a, there is shown an example first interactive category selection page 701 according to various embodiments. As shown in FIG. 7a, the first interactive category selection page 701 can comprise user selection buttons 705 and static advertisements 710. In various embodiments, the static advertisements 710 can comprise advertisement impressions. It should be noted that the static advertisements 710 and advertisement impressions are distinct from the targeted advertisements provided to the user device in response to the user's category selections. An advertisement impression can comprise a single instance of a view of a static advertisement on a page. The targeted advertisements can comprise one or more commercials or commercial segments selected based on the user's category selections. The commercials and commercial segments can comprise digitized (non-static) advertisement content that is viewed or played at the user device 11. The interactive viewer test that determines access to the license key is associated with the targeted advertisements and commercial segments.

Returning to FIG. 7a, in various embodiments, the first category selection can be the user's gender (e.g., male or female). Various embodiments can comprise receiving the user's first category selection from the user device 11 indicating the user's gender. For example, the first category selection can be received from the user device 11 as data in an interactive HTML-formatted page. Furthermore, in various embodiments the ad content server 132 can output a second interactive category selection page to the user device 11. With respect to FIG. 7b, there is shown an example second interactive category selection page 702 according to various embodiments. As shown in FIG. 7b, the second interactive category selection page 702 can comprise the static advertisements 710 and user selection buttons 715. In various embodiments, the second category selection can comprise one or more user content preferences such as, for example, the user's preferred movie genre (e.g., horror, action, western), preferred music genre (e.g., rock, classical), sports, cars, fashion, health, food/cooking, and others. Various embodiments can comprise receiving the user's second category selection from the user device 11 indicating the user's ad content preferences. For example, the second category selections can be received from the user device 11 as data in an interactive HTML-formatted page.

In various embodiments, first time customers can see the screens shown in FIG. 7a and FIG. 7b. Returning customers can see the screens shown in FIG. 7a and FIG. 7c. As shown in FIG. 7c, for returning customers (users), the user device can remember the selections the user last entered.

From 245, the method 200 can proceed to 247 to determine if the user is a first time customer or user. If so, the method 200 can proceed to 249, at which the selected categories can be stored on the user device 11 using cookies. If not, the method 200 can proceed to 251 at which the returning customer or user can choose to continue with the previous selections, or change the selections before proceeding. If at 251 the returning customer or user wants to change his category selections, then the method 200 can proceed to 253 at which the returning customer or user can change his category selections. From 253, the method 200 can proceed to 249, at which the changed category selections can be stored on the user device 11 using cookies.

The method 200 can then proceed to 255, at which the user device 11 can click start ad 720 as shown in FIG. 7b or 7c to complete the category selections and request to start viewing the targeted advertisements. In various embodiments, the user request to start the viewing of targeted advertisements at 255 will trigger the ad web server 131 to request a pass code from the license clearing house 14 at 257. In various embodiments, the request can be made using a secure channel such as, for example, a Secure Socket Layer (SSL) session. Upon receiving the pass code, the method 200 can proceed to 259, at which the ad web server 131 can construct a series of interactive viewer tests based on the pass code provided by the license clearing house 14.

The method 200 can then proceed to 271. At 271, in various embodiments, the ad web server 131 can output the ad viewing page(s) to the user device 11, which, according to various embodiments, can comprise the commercial screen 902, advertisement link 1005, and ad cart 1010. The method 200 at 271 marks the beginning of the targeted advertisement viewing, which can comprise playback of several commercial segments. For example, ten 30 second commercials can be output to the user device 11. In various embodiments, the series of interactive viewer tests and user selection to ad cart can also proceed in parallel.

The method 200 can then proceed to 273. At 273, in various embodiments, the ad interactive web interface 112 on the user device 11 can pseudo-randomly select and send one of the user selected categories stored using cookies to the ad content server 132. Upon receiving the one category selection, the ad content server 132 can output one segment of targeted advertisement or commercial to the user device 11 based on the received category selection. Various embodiments can comprise repeating the process at 273 until the user device 11 completes the viewing of the entire series of targeted advertisements or all segments of commercials at 275. In various embodiments, the series of targeted advertisements can be based on the category selections stored on the user device 11 using cookies. An index of the available advertisements and an association of each advertisement with one or more of the category selections can be maintained by the ad content server 132. In various embodiments, no user personal information or profile information is maintained on any of the servers 121, 122, 131, and 132. A commercial segment can comprise a digitized commercial in the form of a multimedia file comprising a fixed or variable playback duration.

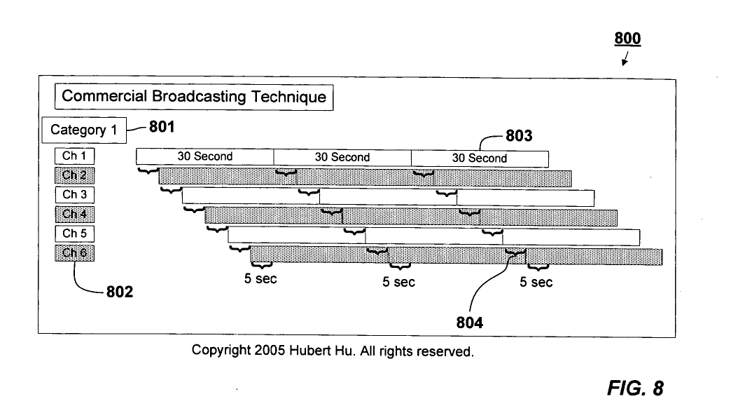

In addition, various embodiments can comprise providing a plurality of channels for each category and associating multiple commercial segments of the same category with each of the channels. For example, six channels of commercial segments can be provided. With respect to FIG. 8, there is shown a timing diagram of a commercial broadcasting method 800 according to various embodiments. As shown in FIG. 8, each category 801 can be associated with multiple channels 802. For example, as shown in FIG. 8, six channels 802 of commercial segments 803 can be available for each category 802. Furthermore, in various embodiments, each channel 802 can comprise an identical series of commercial segments 803 associated with the same category 802. All six channels 802 can be broadcast or multicast to the user device 11 using the network 15 according to an offset gap period 804. For example, as shown in FIG. 8, the offset gap period 804 can comprise an offset gap of 5 seconds. The offset gap period allows a user the capability to begin viewing the commercial segment at any time and the maximum wait for the commercial to begin is equal to the offset gap period 804. Furthermore, in various embodiments, each commercial segment 804 can comprise an associated segment period. The segment period can comprise the playback duration of the segment. In various embodiments, the segment period can be the same for each commercial segment of a channel. For example, the segment period can comprise 30 seconds. Further, the commercial segment 804 playback start time for each channel can be offset by the offset gap period 804. In various embodiments, the offset gap period 804 can comprise an amount of time equal to the segment period divided by the number of channels 802 for the category 801. As shown in FIG. 8, the offset gap period 804 is 5 seconds, which is equal to the segment period of 30 seconds divided by the number of channels 802, which is six. Other variations are possible. For example, if we dedicate fifteen channels 802 to one category 801, then the offset gap period 804 (e.g., maximum wait time) would decrease to 2 seconds. Thus, the maximum wait time for the user to begin viewing commercial segments can be adjusted depending on available resources.

In alternative embodiments, commercial segments 803 can be broadcast or multicast to the user device 11 in accordance with the User Data Protocol (UDP). In other alternative embodiments, the commercial segments 803 can be streamed to the user device 11 on demand using TCP.

In various embodiments, the ad web server 131 can be configured to output a series of interactive viewer tests in conjunction with the digitized targeted advertisements or commercial segments to the user device 11. At 261, the ad web server 131 can output one out of a series of interactive viewer tests to the user device 11. In various embodiments, the ad web server 131 can receive the interactive viewer test response from the user device 11 and verify the test response at 263. Upon successful completion of the current interactive viewer test, the user device 11 can be given the next interactive viewer test in the series at 261 if user device 11 has not completed the entire series of interactive viewer tests. Upon successful completion of the series of interactive viewer tests, the method 200 proceeds to FIG. 4c at 279. Various embodiments can also comprise stopping the targeted advertisement viewing if user device 11 fails to pass the interactive viewer test, at which the user device 11 can choose to restart the targeted advertisement viewing at 257 or end at 299.

In various embodiments, the interactive viewer test can comprise one or more inquiries that are output to the user device 11 during the playing or viewing of the targeted advertisements or commercial segments on the user device 11. Alternatively, the interactive viewer test can be output to the user device 11 before or after the playing or viewing of the commercial segments, or any combination of before, during, and after playing or viewing of the commercial segments. In various embodiments, the interactive viewer test can comprise, for example, a timed Turing test capable of distinguishing human input from non-human input. Further, the interactive viewer test can comprise at least one question designed to confirm that the user has viewed the targeted advertisements or commercial segments. In various embodiments, the interactive viewer test can comprise question(s) that are unrelated to the content of the targeted advertisements or commercial segments. For example, the interactive viewer test can comprise a timed Completely Automatic Public Turing test to tell Computers and Humans Apart (CAPTCHA™) test. Further information regarding the CAPTCHA™ test is available from, for example, the World Wide Web (WWW) at http://www.captcha.net provided by Carnegie Mellon University.

The interactive viewer test can determine whether or not the commercial segments have been viewed by the user. For example, the ad web server 131 can be configured to provide a combination of CAPTCHA™ tests (http://www.captcha.net/) and time restrictions to enforce the mandatory viewing of advertisements as follows. In various embodiments, the ad web server 131 can be configured to output to the user device 11 one or more times (for example, three to six times) throughout the series of targeted advertisements a single distorted and/or obscured letter or digit that appears at a random location on the advertisement or commercial screen at random time intervals. In various embodiments, the letter or digit can comprise a randomly-selected color. The letter or digit may not be case sensitive. Upon noticing the single distorted and/or obscured letter or digit at the user device 11, in a timed aspect of the interactive viewer test, the user must enter the matching letter or digit using a data entry capability of the user device 11 on their first attempt before the allotted time period (for example, a few seconds such as 3 to 5 seconds) runs out. In various embodiments, the interactive viewer tests will be different for every user. In various embodiments, data such as the expected or correct user responses to the interactive viewer tests can be stored using the data storage device.

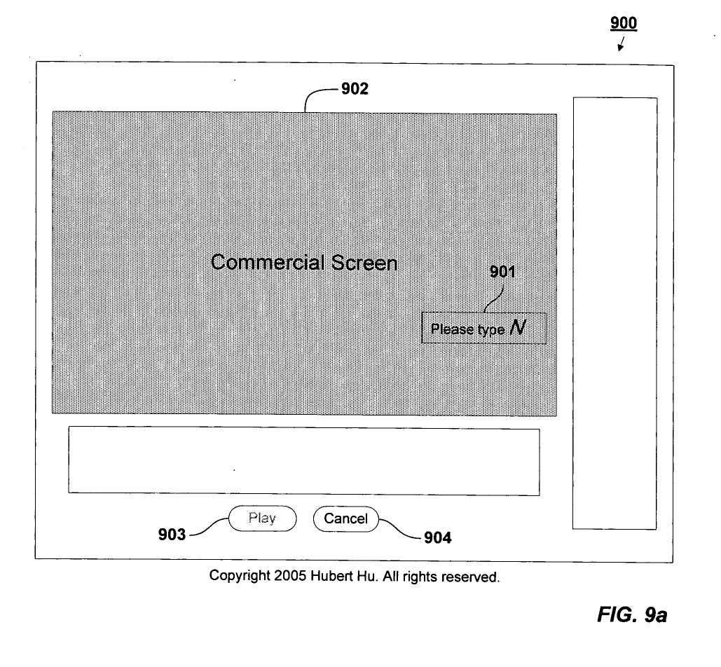

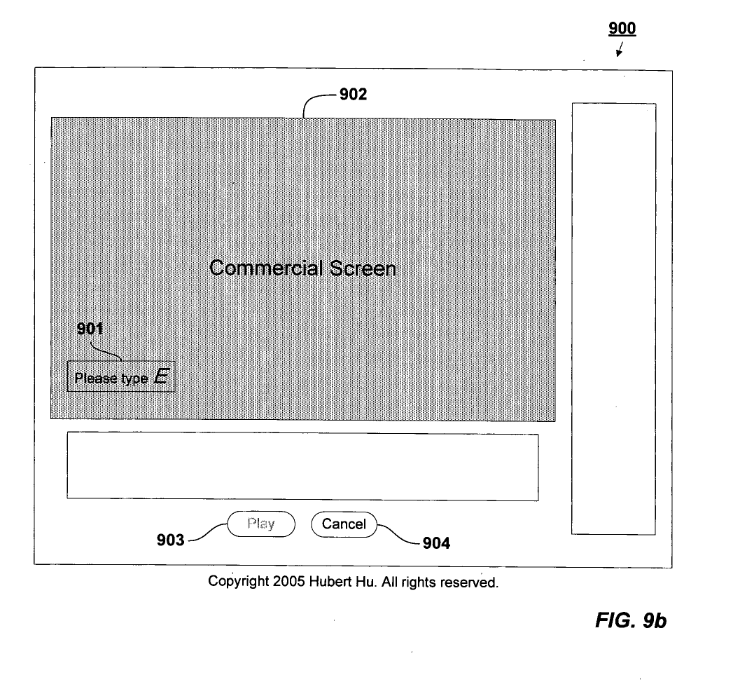

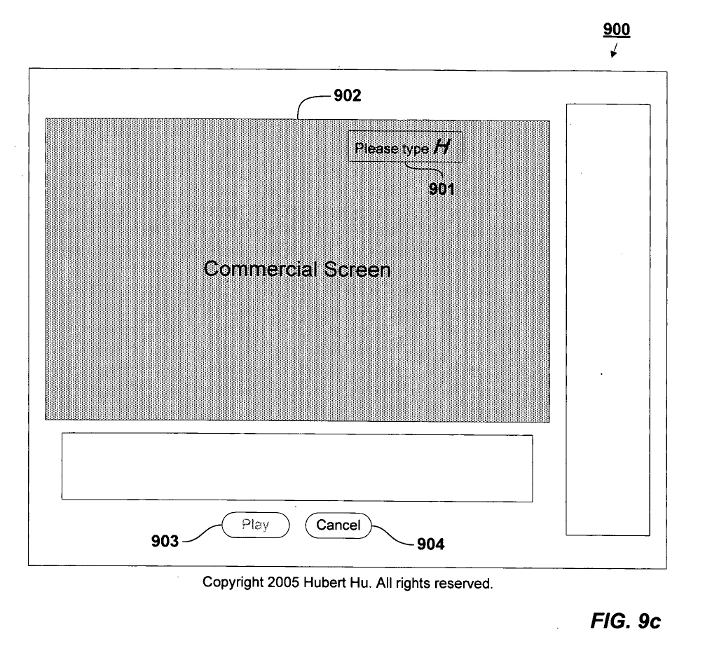

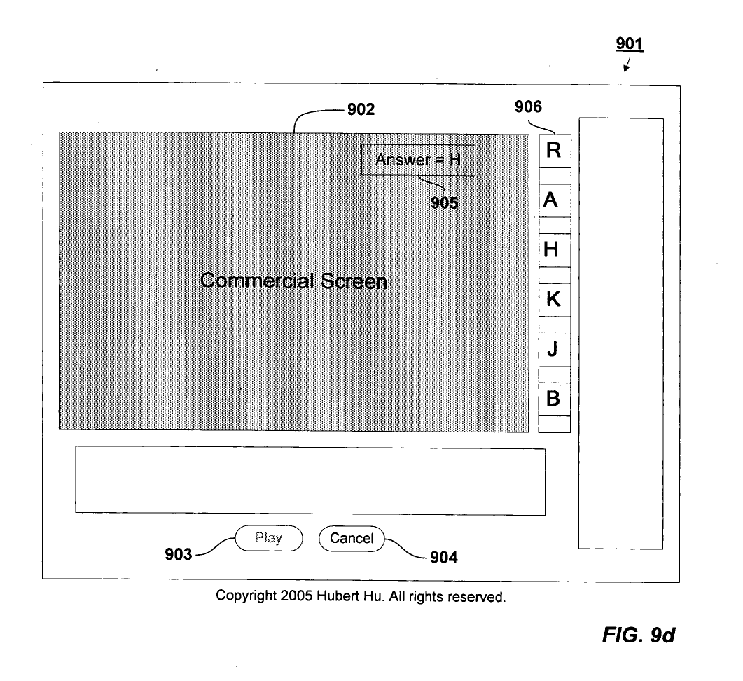

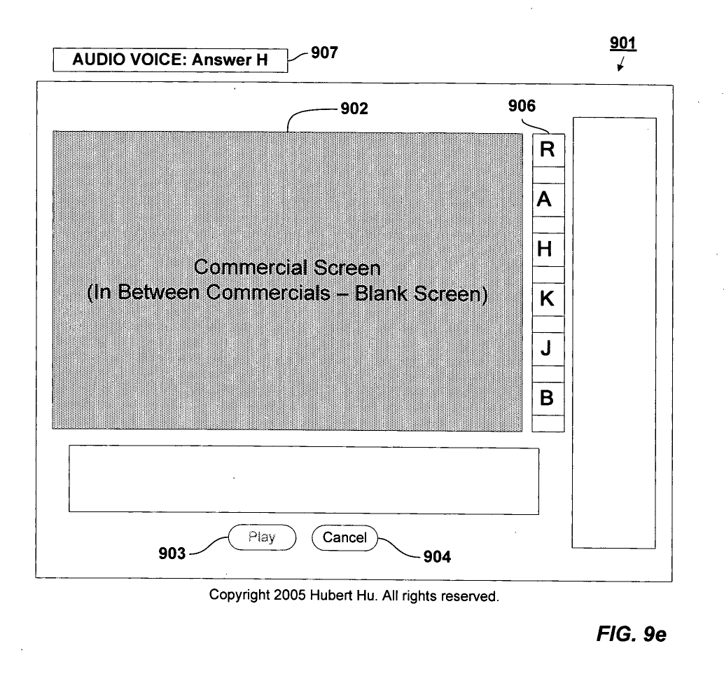

With respect to FIGS. 9a through 9c, there is shown an example interactive viewer test page 900 in accordance with various embodiments. As shown in FIGS. 9a through 9c, the interactive viewer test page 900 can comprise a test message 901. In various embodiments, the test message 901 can comprise a single distorted and/or obscured letter or digit that appears at a random location on the advertisement or commercial screen at random time intervals. In various embodiments, the test message 901 can comprise one or more user instructions. Alternatively, the test message 901 can be provided without any instructions to the user. FIGS. 9a through 9c assume a total of three CAPTCHA™ tests, for example. With respect to FIG. 9a, there is shown an interactive viewer test page 900 in which the test message 901 requests the user to enter the letter “N” at the user device 11. Similarly, FIG. 9b shows an interactive viewer test page 900 in which the test message 901 requests the user to enter the letter “E.” FIG. 9c shows an interactive viewer test page 900 in which the test message 901 requests the user to enter the letter “H.” In FIGS. 9a through 9c, the letters “N,” “E,” and “H” can be distorted and/or obscured, requiring the user to apply human ability to discern the digit/letter. Throughout the playback of the commercial segments, also as shown in FIGS. 9a through 9c, the test message 901 can appear at random times and at random locations throughout the commercial display area 902. Thus, for the series of interactive viewer tests shown in FIGS. 9a through 9c, the correct sequence of test responses to be received from the user via the user device 11 is “N,” “E,” and “H,” in that order. In various embodiments, the interactive viewer tests can be unrelated to the advertisement content or context, as shown in FIGS. 9a through 9c. In this way, the user is not overly burdened by having to recall details of one or more advertisements, but is still verified to have viewed the targeted advertisements with a relatively lower failure rate for the interactive viewer tests.

With respect to FIG. 9d and FIG. 9e, there is shown another example of the interactive viewer test page 901 in accordance with various embodiments. As shown in FIG. 9d, the interactive viewer test page 901 can comprise a test answer message 905 and a list of CAPTCHA™ choices 906. The list of CAPTCHA™ choices 906 can comprise multiple distorted letter or digit choices including the test answer message 905. Throughout the playback of the at least one targeted advertisement (for example, one or more commercial segments), the test answer message 905 can appear at random times and at random locations throughout the commercial display area 902. Upon the test answer message 905 appearing, the user at user device 11 can be required to click on the matching CAPTCHA™ choice from the list of available CAPTCHA™ choices 906 before the allotted time period (for example, a few seconds such as 3 to 5 seconds) runs out. As shown in FIG. 9e, the interactive viewer test page 901 can comprise an audio test answer message 907 and a list of CAPTCHA™ choices 906. The list of CAPTCHA™ choices 906 can comprise multiple distorted letter or digit choices including the audio test answer message 907. In various embodiments, the audio test answer message 907 can be provided to the user at user device 11 in between playback of targeted advertisements or commercial segments. Upon hearing the audio test answer message 907, the user at user device 11 can be required to click on the matching CAPTCHA™ choice from the list of available CAPTCHA™ choices 906 before the allotted time period (for example, a few seconds such as 3 to 5 seconds) runs out. One benefit of administering an interactive viewer test page 901 as shown in this example is that the user at user device 11 does not have to use a keyboard device to enter the correct answer, but instead can select the correct answer from among a few listed CAPTCHA™ test answer choices 906. This can result in fewer failed interactive viewer tests than may occur using the first example interactive viewer tests. Furthermore, having the audio test answer message 907 to be a part of the interactive viewer tests ensures that the user at user device 11 is watching the at least one targeted advertisement or commercial segments with an audio output device, which can be required for advertisement or commercial viewing.

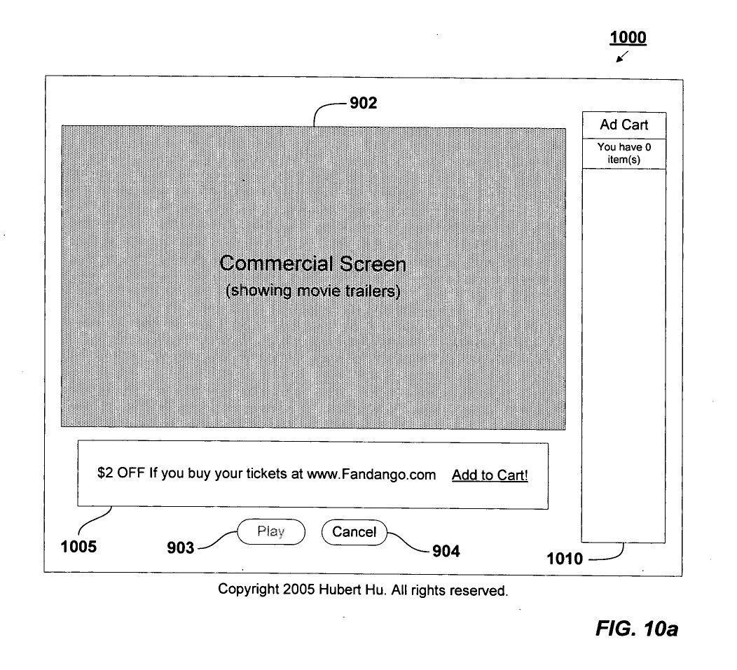

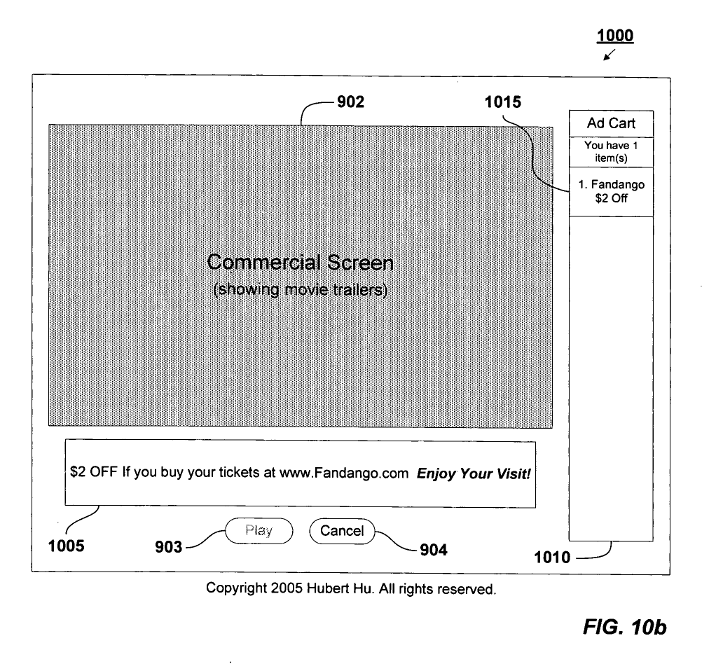

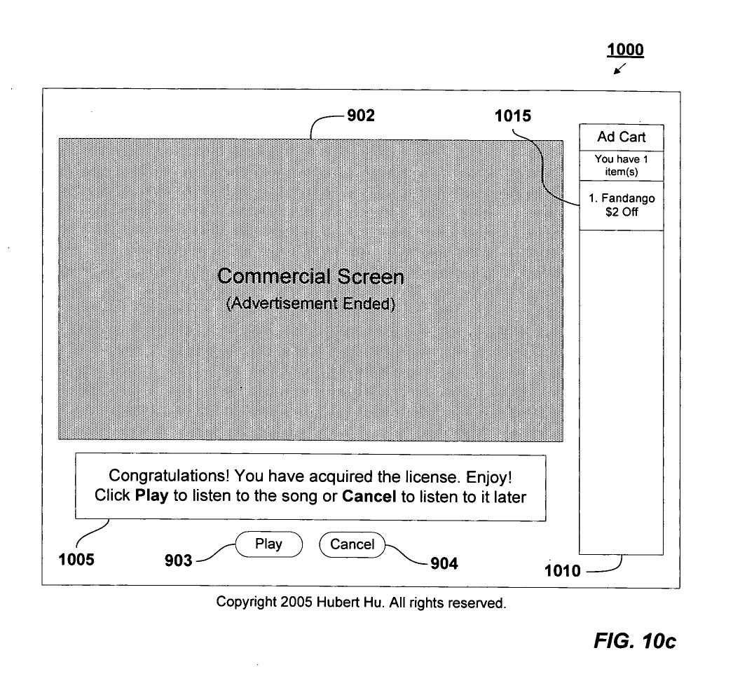

In parallel to the targeted advertisement viewing and the interactive viewer tests, the method 200 can also perform 277. Various embodiments can comprise the ad web server 131 outputting one or more contextually related advertisement links during each segment of targeted advertisement or commercial playback and providing user device 11 the capability to collect the advertisement links in the ad cart to view later. Each of the advertisement links can, for example, comprise a message that informs the ad cart 1010 in FIGS. 10a-10c to store the hypertext link to a World Wide Web (WWW) page using cookies. With respect to FIGS. 10a through 10c, there is shown an example advertisement page 1000 in accordance with various embodiments. As shown in FIGS. 10a through 10c, the advertisement page 1000 can comprise the commercial display area 902, the play button 903 and cancel button 904, a link display area 1005 for displaying advertisement links, and an ad cart 1010 for collecting selected advertisement links. The user device 11 can select individual advertisement links of interest, and each selected advertisement link can be collected into the ad cart 1010 as shown in FIGS. 10a through 10c. Applicable discounts or special deals, if any, can also be displayed next to the links in the link display area 1005 as shown in FIG. 10a. In this way, users can collect the links when they find something of interest. (i.e. a great product, or discount deals).

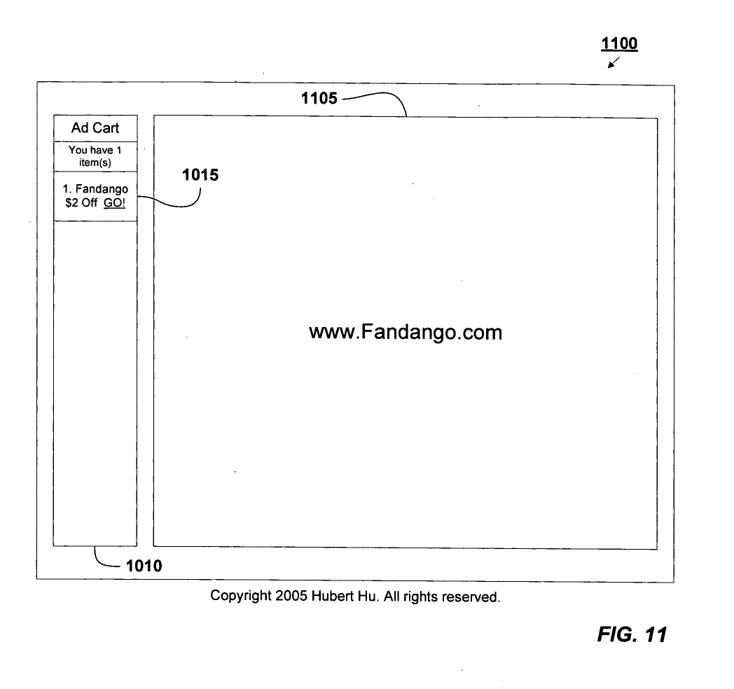

In an embodiment, throughout the commercial viewing, the user at the user device 11 can choose to add advertisement links to an ad cart. When an item is added to the ad cart, the advertisement link (i.e. Fandango.com) can be stored at the user device 11 using cookies. When the commercial viewing is finished, the user can choose to Play the digital content or Cancel for later. In various embodiments, user selection to either play or cancel the digital content can close the ad interactive web interface 112 and prompt the ad cart in a new browser page. To accomplish this, the ad web server 131 can send an HTML-formatted page to the user device 11 when the ad interactive web interface 112 is closed. The HTML-formatted page can retrieve the links stored using the cookies and re-display the ad cart in a new interactive page as shown in FIG. 11.

Upon successful completion of the series of interactive viewer tests, the method 200 can proceed to 281 as shown in FIG. 4c. In various embodiments, the series of interactive viewer tests is based on the pass code provided by the license clearing house 14. Therefore, the user device 11 will be in possession of the pass code after completing the interactive viewer tests. The method 200 can then proceed to 281, at which the user device 11 sends the pass code to the license clearing house 14.

According to various embodiments, upon receiving the pass code from the user device 11, the license clearing house 14 can authenticate the pass code at 283 and generate a license key to be sent to the user device 11. In various embodiments, the user device 11 can receive the license key and activate the digital content to view, play, or playback.

The method 200 can then proceed to 289, at which the digital content can be viewed or played at the user device 11 responsive to the license key, which allows the digital content to be decrypted for playback. The user can also cancel playback using, for example, the cancel button 904 as shown in FIGS. 9a through 9c, and listen to or playback the digital content later (reference FIG. 10c). During playback of the targeted advertisements or commercial segments, a user can actuate the cancel button 904 to exit at any time. In various embodiments, users who fail to timely and accurately answer the interactive viewer tests or who cancel can be forced to terminate the targeted advertisement viewing and asked to restart the process or exit.

The method 200 can then proceed to 291, at which the user can share activated content to another user. However, the other user must accomplish steps 237 through 289 before being able to view, play, or playback the digital content.

The method 200 can then proceed to 293 to determine if the ad cart has selections in it. If the ad cart is empty, then the method 200 can end at 299. If the ad cart has selection in it, then the method 200 can proceed to 295.

At 295, the ad web server 131 can output a new HTML page to the user device that retrieves the advertisement links in the ad cart stored on the user device 11 using cookies and redisplay the ad cart. The ad cart 1010 of the ad interactive web interface 112 can comprise a collection of advertisement links. With respect to FIG. 11, there is shown an ad cart selection page 1100 according to various embodiments. As shown in FIG. 11, the ad cart selection page 1100 can comprise the ad cart 1010 and its contents 1015 as well as the page or frame information 1105 associated with the selected link. In response to the user closing the ad interactive web interface, or by clicking or selecting the “Play” 903 or “Cancel” 904 buttons, the ad cart selection page 1100 can be provided.

The method 200 can then proceed to 297, at which the user can click on or select the advertisement links in the ad cart and visit the associated WWW sites. Thus, in various embodiments, users can browse through the links in the ad cart to take advantage of the discount or special deals. In various embodiments, the browser application of the user device can be redirected to a Uniform Resource Locator associated with one of the advertisement links upon receiving a user selection of that advertisement link from the ad cart.

The method 200 can then proceed to 299, at which the method 200 can end.

In various embodiments, the user can be provided the capability to use, view, or play the digital content on more than one user device 11 in exchange for viewing additional amounts of targeted advertisements. For example, three minutes of six 30 second targeted advertisements or commercials must be viewed in order to secure a license key to access the digital content on two different user devices 11 such as, for example, one PC and one portable music device; four minutes must be viewed in order to gain access on three different user devices 11; and five minutes must be viewed in order to gain access on four different user devices 11, etc.

In various embodiments, providing digital content can comprise the user device 11 downloading a digital file from the product file server 122 to the user device 11 in response to a request for the file received from the user. Alternatively, the digital content can comprise non-downloadable digital content. In such embodiments, the targeted advertisements can be provided together with the non-downloadable digital content. Playback of the targeted advertisements can occur before, during, or after playback of the non-downloadable digital content. Furthermore, the amount of the non-downloadable digital content allowed to be played at the user device can be based on the number of targeted advertisements viewed.

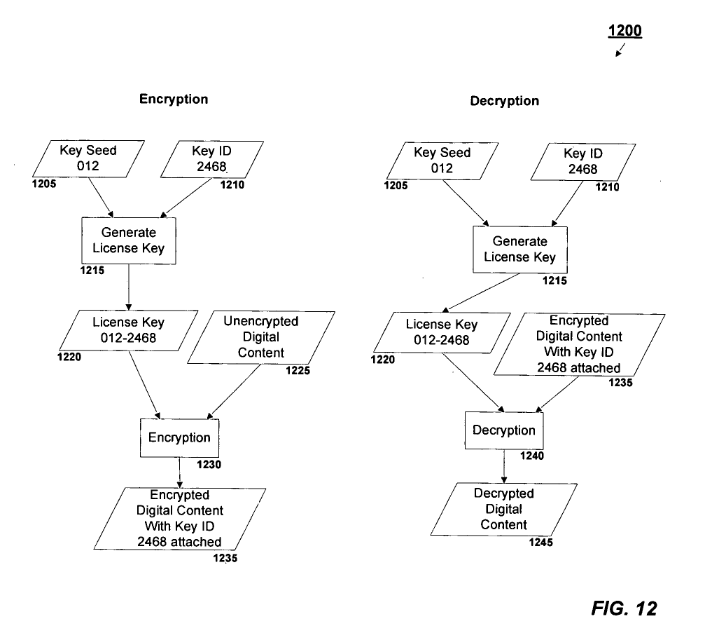

With respect to FIG. 12, there is shown a license key generation method 1200 according to various embodiments. The key seed 1205 is a shared secret between the content packager (for example, product file server 122) and the license clearing house 14. As shown in FIG. 12, a key seed 1205 and a key ID 1210 can be used to generate a license key 1220. In various embodiments, a single key seed 1205 along with different key IDs 1210 can be used to generate unique license keys 1215. Further, in various embodiments, a different key seed 1205 can be used for digital content received from different sources. For example, all songs from Sony Music can use the same key seed 1205, and songs from EMI Records can use a different key seed 1205. Thus, if music files are obtained from three different record companies, then the license clearing house 14 can hold three different key seeds 1205 for use by the content access system 10.

In various embodiments, the key seed 1205 and key ID 1210 can comprise random values of varying length. For example, the key seed 1205 can be “012,” and the key ID 1210 can be “2468” as shown in FIG. 12. In various embodiments, the encryption process 1230 can comprise encrypting the unencrypted digital content 1225 with the license key 1220 to create the encrypted content 1235. Attached to the header of the encrypted digital content 1235 can be the key ID “2468” and the license acquisition URL. In various embodiments, the digital content encrypted with the key ID attached can comprise the product available to any user to receive via, for example, but not limited to, product download.

Once the user device 11 is allowed to receive the license key 1220, the user device 11 can request for the license key 1220 by sending the key ID 1210 to the license clearing house 14. With the corresponding key seed 1210, the license clearing house 14 can generate and return the license key 1220 to the user device 11 for decrypting the digital content. Upon receiving the license key 1220, the application on user device 11 that is used to view or play or playback the digital content can decrypt the digital content as the application views, plays, or plays back the digital content at the user device 11. For example, in various embodiments, the Windows™ Media Player™ application comprises a built-in decryption algorithm that decrypts digital content using, for example, the license key as it is played by the Windows™ Media Player™ application. Other applications can be used as well. In various embodiments, the digital content is not stored in the decrypted state at the user device 11.

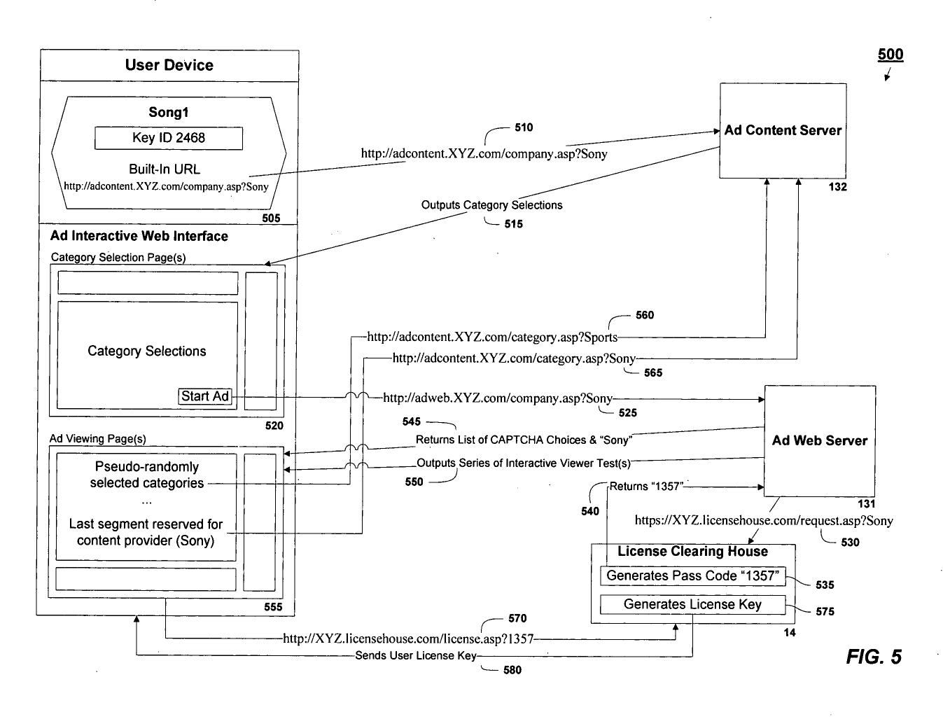

With respect to FIG. 5, there is shown a detailed license key acquisition method 500 according to various embodiments. As shown in FIG. 5, the user device 11 has in possession an encrypted digital content Song1 at 505. In various embodiments, the product file server 122 can include one or more encoders that are used to encrypt all digital content stored on the product file server 122 such that all digital content stored on the product file server 122 can be scrambled and attached with a key ID and built-in URL as shown in FIG. 5 at 505. Furthermore, the encoder(s) can use different key seeds to encrypt digital content such that only the key seed used for encryption can be used to generate the license key to decrypt the digital content.

Upon opening the digital content Song1 in FIG. 5 at 505, the user device 11 can connect to the ad content server 132 specified by the built-in URL http://adcontent.XYZ.com/company.asp?Sony, at 510. In various embodiments, the ad content server 132 can output the category selection page(s) 520 to the ad interactive web interface 112 on user device 11. (Additional detail regarding category selection is described with respect to FIG. 4b, step 245.) After user selects the categories which are stored on the user device 11 using cookies, the user can click the button “Start Ad” to connect to the ad web server 131 specified by the URL http://adweb.XYZ.com/company.asp?Sony, at 525. Furthermore, according to various embodiments, the ad web server 131 can request a pass code from the license clearing house 14 specified by the URL https://XYZ.licensehouse.com/request.asp?Sony, at 530. In various embodiments, the request 530 can be made using a secure channel such as, for example, a Secure Socket Layer (SSL) session. Since the company information Sony is also passed along to the license clearing house 14 as the request is made, the license clearing house 14 can generate a pass code that corresponds to the key seed used for digital content from Sony. For example, if the company information Sony is passed along in the request, the license clearing house 14 can generate a pass code so when the user device 11 uses the pass code to request a license key, the license clearing house 14 will know that the pass code is for a Sony digital content, which means the license clearing house 14 will know which key seed to use to generate the license key.

In various embodiments, a unique license key seed can be provided for each different product source. For example, if the user selected digital content from three sources, then three license keys can be generated by the license clearing house 14 using the corresponding unique key seeds. In various embodiments, every item of digital content can have a unique key ID attached, and each source of digital content can have a unique key seed. Therefore, each item of digital content requires a unique license key for viewing/playback. For example, if the user selected digital content comprising music files that are provided by three different record companies (for example, Sony Music, EMI Records, and Warner Music), then in various embodiments music files or songs from Sony Music can have the URL “http://adcontent.XYZ.com/company.asp?Sony” built into them, music files from EMI Records can have the URL “http://adcontent.XYZ.com/company.asp?EMI” built into them, and music files from Warner Music can have the URL “http://adcontent.XYZ.com/company.asp?Warner” built into them. The URLs provide two pieces of information. The first piece of information can comprise the URL address (e.g., “adcontent.XYZ.com”) which tells the ad content server 132 to output the category selection page(s) to the ad interactive web interface 112 on the user device 11. The second piece of information can comprise the content source identifier (e.g, “Sony,” “EMI,” or “Warner”). Given this information, the ad web server 131 can request the appropriate pass code from the license clearing house 14. For example, if the content source identifier is “Sony,” then the ad web server 131 can request the License Clearing House 14 to generate and return a pass code for digital content from Sony, so when the user device 11 uses the pass code to request the license key, the license clearing house 14 can associate the pass code with the Sony key seed. However, other embodiments are possible. For example, in various alternative embodiments, only one key seed can be used for all digital content regardless of the source.

Returning to FIG. 5, in various embodiments, the license clearing house 14 generates and temporarily stores a random pass code “1357”, at 535. A time restriction can be set so that once the pass code is generated, the user device 11 can only use this pass code to request the license key during a specific period of time (for example, between 5 and 5½ minutes since the pass code was generated). Since the ad web server 131 knows when the user device 11 will complete the interactive viewer tests, the pass code will only be valid during a certain period of time. In various embodiments, the license clearing house 14 can then output the pass code to the ad web server 131, at 540.

Upon receiving the pass code “1357”, the ad web server 131 can construct a series of interactive viewer tests based on the pass code “1357” and output a first list of CAPTCHA™ choices including the pass code “1”, “3”, “5”, “7” along with an indication of the source “Sony” to the ad interactive web interface 112, at 545. In various embodiments, the ad web server 131 can output the ad viewing page(s) 555 to the user device 11 in the ad interactive web interface 112, while also outputting a series of interactive viewer tests to the ad interactive web interface 112 on user device 11, at 550. In various embodiments, the company information Sony can be output to the ad interactive web interface 112 on user device 11 for the purpose of reserving the last targeted advertisement or commercial segment for the content provider Sony. In various embodiments, for example, the first interactive viewer test can retrieve a second list of CAPTCHA™ choices 906, which includes the first part of the pass code “1”, from the first list of CAPTCHA™ choices, and output the second list of CAPTCHA™ choices 906 along with a test answer message 905 to the ad viewing page(s) 545. In various embodiments, for example, with the pass code “1357”, the expected answer for the interactive viewer test can be “NEHL”, with “N” representing “1” of the pass code, “E” representing “3”, “H” representing “5”, and “L” representing “7” of the pass code. Furthermore, a more complicated pass code can be used such as “1H53-7S42-19M3-Z132”, at which the expected answer for the interactive viewer test can be “NEHL”, with “N” representing “1H53” and so forth.

In various embodiments, the ad viewing page(s) in the ad interactive web interface 112 can consist of algorithms implemented in javascript/vbscript which executes the following multiple times as required:
A. At 555, the ad interactive web interface 112 can pseudo-randomly select one of the categories stored via cookies and construct and output a URL to the ad content server 132, for example, http://adcontent.XYZ.com/category.asp?Sports and accesses the URL to stream the ad content from the ad content server 132 to the user device 11 on the commercial screen, at 560. In various embodiments, the last targeted advertisement or commercial segment can be reserved for the company providing the digital content, at 555. The ad interactive web interface 112 can then output an ad content request URL based on the product source (for example, “Sony”) to the ad content server 132, for example, http://adcontent.XYZ.com/category.asp?Sony, at 565. (Additional detail regarding this process is described with respect to FIG. 4b, step 271.)
B. The series of interactive viewer tests can be administered in parallel to the viewing of targeted advertisements or commercial segments.

In various embodiments, the ad web server 131 can verify the response to the interactive viewer test before allowing the user device 11 to continue with the next interactive viewer test and the targeted advertisement viewing. In the event of a user failing the interactive viewer test, various embodiments can comprise forcing the user device 11 to restart the advertisement viewing process, for which the ad web server 131 can request a newly generated pass code from the license clearing house 14 and output a new series of interactive viewer tests based on the newly acquired pass code. Upon successful completion of the targeted advertisement viewing and interactive viewer tests, the user device 11 will have collected the correct responses to the interactive viewer tests, which can represent the pass code generated by the license clearing house 14. In various embodiments, the user device 11 now has the pass code to contact the license clearing house 14.

In various embodiments, the user device 11 can contact the license clearing house 14 via the URL http://XYZ.licensehouse.com/license.asp?1357, at 570, and provide the pass code “1357”. With the pass code, the license clearing house 14 can determine which key seed to use to generate the license key at 575. Upon authenticating the pass code, the license clearing house 14 can, in response to receiving a request for the license key from this specific user device 11, use the key ID provided by the user device 11 and the key seed determined by the license clearing house 14 to generate and return the license key to the user device 11, at 580. Upon obtaining the license key, the user device 11 can then view or play or playback the digital content at the user device 11. In various embodiments, the user device 11 can comprise a media player application that activates the digital content upon receiving the license key.

With respect to FIG. 13, there is shown a schematic block diagram of a computing device or platform 1300 useful for hosting such software application programs according to various embodiments. In various embodiments, the computing device 1300 can be used to implement the user device 11 and/or the servers 121, 122, 131, and 132. Other computing devices may be used, as discussed herein. The application software when executed by a processor of the computing platform 1300 can cause the computing platform(s) to be configured to perform the functions described herein. As shown in FIG. 13, the computing device 1300 can comprise a processor 31, Read Only Memory (ROM) 32, Random Access Memory (RAM) 33, a communications interface 34, a user interface 35, and non-volatile storage 36. Each of these components may be coupled using a bus 37. In various embodiments, the non-volatile storage 36 can be a hard disk drive or other non-volatile storage device such as, for example, a memory stick or USB-accessible storage device such as an external hard disk drive or a floppy disk drive. Programmed instructions can be stored or maintained in non-volatile storage 36, ROM 32, or a combination thereof, or may be received from a network via the communications interface 34. Instructions may be loaded into RAM 33 and/or various processor registers for execution by the processor 31. When executed by the processor 31, the instructions can cause the processor 31 and computing device 1300 to be configured to perform operations specified by the instructions. The computing device 1300 can comprise a standard set of peripherals such as, but not limited to, a display, printer, keyboard, and mouse device accessible via the user interface 35.

The processor 31 can comprise any microprocessor or microcontroller configured to execute software instructions implementing the functions described herein. Application executable instructions/APIs and operating system instructions may be stored using computing platform 1300 non-volatile memory 36 or ROM 32, and then loaded into volatile memory or RAM 33 for execution. Application executable instructions/APIs can comprise software application programs implementing the user device 11 or servers 121, 122, 131, and 132, the browser application of the user device 11, and software portions of a data storage device. Operating system instructions can comprise software instructions operable to control basic operation and control of the processor 31. In one embodiment, operating system instructions can include the Linux operating system available from, for example, Redhat Systems, Inc. of Raleigh, N.C. Other embodiments are possible. For example, Windows™ operating system available from Microsoft Corporation of Redmond, Wash. or the NT™ operating system available from Microsoft Corporation may be used. In at least one embodiment, the computing platform may be a PC provided by Dell Computer of Round Rock, Tex.

The application programs can each reside on a single computing platform 1300, or on more than one computing platform 1300, or each application may reside on a separate computing platform 1300. In various embodiments, the servers 121, 122, 131, and 132 can be scaleable such that additional resources may be added as required to increase capacity, speed, or number of users served, or to maintain system 10 capabilities as users increase. Application executable instructions/APIs and operating system instructions can be loaded into one or more allocated code segments of computing platform 1300 volatile memory or RAM 33 for runtime execution. In various embodiments, application executable instructions/APIs can comprise a sequence of Java instructions in a script. Other embodiments are possible. For example, the application executable instructions/APIs can comprise a sequence of Visual Basic™ or C/C++ instructions. Application executable instructions/APIs can comprise one or more application program interfaces (APIs). The content access application program can use APIs for inter-process communication and to request and return inter-application function calls. For example, an API can be provided in conjunction with the data storage device in order to facilitate the development of SQL scripts useful to cause the data storage device to perform particular data storage or retrieval operations in accordance with the instructions specified in the script(s). In general, APIs may be used to facilitate development of application programs which are programmed to accomplish the functions described herein, such as the addition of new modules and integration with third party products.

Returning to FIG. 13, the communications interface 34 can provide the computing platform 1300 the capability to transmit and receive information over the Internet, including but not limited to electronic mail, HTML or XML formatted pages, and file transfer capabilities. To this end, the communications interface 304 may further include a web browser such as, but not limited to, Netscape Navigator™ or Microsoft Internet Explorer™. The user interface 35 can comprise a computer terminal display, keyboard, and a pointing device such as a mouse device. One or more Graphical User Interfaces (GUIs) also may be included to provide for display and manipulation of data contained in interactive HTML pages. The user interface 35 can communicate with the browser. The browser application may be, for example, but not limited to, web-based.

To access the system 10, in various embodiments, a user can enter the Uniform Resource Locator (URL) associated with the content access system 10 into the address line of the browser application at the user device 11, which may be a World Wide Web (WWW) browser application. Alternatively, a user may select an associated hyperlink contained on an interactive page using a pointing device such as a mouse or via keyboard commands. This may cause an HTTP-formatted message to be transmitted from the product web server 111 to the user device 11 (after Internet domain name translation to the proper IP address by an Internet proxy server) requesting the content. In an embodiment, the product web server 121 can output the requested information to the requesting user device 11 as an HTML-formatted page. For example, in response, the product web server 121 can establish a session and generate and transmit a corresponding interactive HTML-formatted page to the requesting user device 11. The HTML page can comprise data entry fields in which a user may enter information. The user can enter the prompted information into the appropriate data entry fields of the HTML page and cause the user device 11 to transmit the entered information to the servers 121, 122, 131, and 132.

In various embodiments, the data storage device 36 can comprise a database management system (DBMS) in which data is accessed, stored, and retrieved in accordance with the Structured Query Language (SQL) database format. In various embodiments, the data storage device 36 can be implemented using SQL Server provided by Microsoft Corporation, or similar products provided by Oracle® Corp. of Redwood Shores, Calif. or the open source MySQL®. The data storage device 36 can execute a sequence of SQL scripts operative to store or retrieve particular items arranged and formatted in accordance with a set of formatting instructions. For instance, the data storage device 36 can execute one or more SQL scripts in response to a request for particular items of data.

In an example, the content access system and methods described herein can be used to provide access and playback of digital music files. In this example, the first set of countries for which digital content is available can comprise the following ten countries as set forth in Table 1.

TABLE 1
10 Music Sites

| | |
|---|---|
| USA | UK |
| France | Mexico |
| Russia | Japan |
| S. Korea | China |
| India | Taiwan |

For these first set of ten countries for which music is available, the content access system and methods provides music and local targeted advertisements to the user device upon request.

In this example, a second set of countries can be provided for which local targeted advertisements are available. The second set of countries can be, for example, the union of the first set of countries from Table 1 and a number of additional countries for which local targeted advertisements are available as set forth in Table 2.

TABLE 2
Five additional locations for which local ads are available.

Canada
Germany
Singapore
Malaysia
Italy

According to various embodiments, anyone with Internet access can download music from any of the 10 music sites comprising the first set of countries. However, only users residing in the second set of countries (10+5 countries) will have local targeted advertisements to watch and licensing keys to obtain. As described herein, user location can be determined by IP address.

Country-specific content pages for all 10 music sites comprising the first set of countries are available in two languages: 1) the country's native language, and 2) English. Local users visiting a local music site will by default view the music site in the local native language. Foreign users visiting a local music site will by default view the music site in English. Switching between the two languages is possible at all times during the visits. By way of example, a Japanese resident visiting the Japanese music site can be considered a local user, while a U.S. resident visiting the Japanese music site can be considered a foreign user. Alternatively, each music site can be displayed in the country's native language and the user is provided the capability to switch to display in English.

In various embodiments, the first screen a user sees when visiting the website associated with the content access system can comprise a world map as shown in FIG. 6a. The user needs to pick a continent to proceed using, for example, a mouse device. Only continents that have countries for which music is available are selectable. For example, if a user clicks on the North America continent, the user will see a screen shown in FIG. 6b. In FIG. 6b, the list of countries 610 on the right is a display comprising those on the continent for which music sites are available. Music sites can be accessed by clicking on or selecting the countries 610 on the right or by clicking on or selecting the countries on the map (if the country is big enough on the map) as shown in FIG. 6b. As a further example, if a user clicks on or selects the Asia continent, the user will see a screen show in FIG. 6c.

Once the user arrives at a music site, the user can select and download any of the songs provided on the website. Every music site can be designed to reflect its country's culture and flag colors. Depending on the country's music trends, each music site can have one or more genres. In various embodiments, music sites can comprise links to top 20 songs of the week for each genre. Also, a voting system can be provided to allow users to vote, for example, for the top 10 most wanted songs. In various embodiments, the content selection pages can then comprise links to those top 10 most wanted songs the following week.

Continuing on with the music files example, in various embodiments the viewing of targeted advertisements is required for obtaining the licensing keys for product activation. In order to maximize the advertisement viewing experience for customers, and maintain highly effective quality advertisements for advertisers, the method can comprise: 1) category selection, 2) a series of interactive viewer tests, and 3) the ad cart.

Regarding category selection, a user accessing an unlicensed digital content item can trigger output of the category selection page(s). As shown in FIGS. 7a and 7b, the category selection page(s) can comprise two screens with a few selections, both with static advertisements. Users are asked to enter their gender and to choose their most preferred categories from a list (e.g., Choose 5 out of 10 categories). The targeted advertisements that follow are taken only from the chosen categories. First time customers will see the screens shown in FIG. 7a and FIG. 7b. Returning customers will see the screens shown in FIG. 7a and FIG. 7c. As shown in FIG. 7c, for returning customers (users), the user device can remember the selections the user last entered. The returning customer can choose to continue with the same selections, or change the selections and then proceed. As shown in FIG. 8, each category can have six channels. Each channel can display an identical series of commercials that belongs to the same category. All six channels can be broadcast or multicast on the Internet and offset by 5 seconds, so a user can cut in at anytime and the maximum wait for the commercial to start is 5 seconds. Similarly, if fifteen channels are dedicated to one category, then the maximum wait would decrease to 2 seconds. The maximum wait can be adjusted depending on available resources.

Regarding the interactive viewer test, once the preferred categories have been chosen, the viewing of targeted advertisements can commence and the interactive viewer tests can be performed as shown and described with respect to FIGS. 9a through 9c or FIGS. 9d and 9e.

Thus, assume a total of three CAPTCHA™ tests as shown in FIGS. 9a through 9c. If the user enters “N,” “E,” and “H” each timely and accurately on the first attempt, the user will have collected the CAPTCHA™ test inputs “NEH” which represents the pass code, which means the user will have the pass code in possession. The user can then contact the license clearing house to release the licensing key to the user. After receiving the license key, the user can then view or play the content (for example, Play the song).

Thus, the above example illustrates use of the system and methods described herein for accessing one form of digital content. Embodiments can provide access to other kinds of digital content as well.

Thus, various embodiments have been shown comprising systems and methods for providing access to digital content. Various embodiments can comprise providing digital content to a user device, providing at least one targeted advertisement to the user device in which the targeted advertisement(s) comprise files that are separate from the digital content, and outputting one or more interactive viewer tests to the user device during playback of the targeted advertisement(s). The interactive viewer test can comprise at least one question designed to solicit human user input. Further, the question(s) can be contextually unrelated to the content of the targeted advertisement(s). Various embodiments can comprise allowing playback of the digital content by the user device upon successful validation of the user responses and the order in which the user responses are received.

Further, various embodiments can comprise receiving category selections from the user device, and the targeted advertisements can be based on the received category selections.

Various embodiments can also comprise selecting the at least one targeted advertisement based on the location of the user device.

Various embodiments can further comprise outputting one or more advertisement links to the user device. Each of the advertisement links can be contextually related to the targeted advertisement(s). As a user selects individual advertisement link, each selected advertisement link can be collected into an ad cart at the user device. The ad cart can then be output at the user device. Various embodiments can further comprise redirecting a browser application of the user device to a Uniform Resource Locator associated with one of the advertisement links upon receiving a user selection of the advertisement link from the ad cart.

Various embodiments can also comprise outputting a continent selection page to the user device. Based on continent selection, various embodiments can comprise output at least one country selection page to the user device. The country selection page(s) can comprise, for example, a first set of countries for which digital content is available. Country selections can be received from the user device indicating one or more of countries from the first set of countries. Furthermore, various embodiments can comprise outputting at least one country-specific content page to the user device comprising links to country-specific digital content. From the country-specific content page, the user can select country-specific digital content. Further, various embodiments can comprise receiving category selections from the user device, and the targeted advertisements can be based on the received category selections.

In various embodiments, providing the at least one targeted advertisement can further comprise determining user eligibility to receive the at least one targeted advertisement based on the user device being located in a country for which targeted advertisements are available.

In various embodiments, allowing playback can further comprise receiving a license key if both the content of the user responses to the interactive viewer test and the order in which the user responses are received are determined to be correct. In such embodiments, playback of the digital content is allowed in response to receiving the license key.

In addition, various embodiments can comprise providing a plurality of channels for each category and associating multiple commercial segments from the same category with each of the channels. In various embodiments, each commercial segment can have an associated segment period. The segment period can be the same for each commercial segment of a channel. The commercial segment playback start time for each channel can be offset by an amount of time equal to the segment period divided by the number of channels for the category.

Various embodiments can also comprise providing the user the capability to use, view, or play the digital content on more than one user device in exchange for viewing additional amounts of targeted advertisements.

In various embodiments, providing digital content can comprise downloading a digital file to the user device in response to a request for the file received from the user device.

Alternatively, the digital content can comprise non-downloadable digital content. In such embodiments, the targeted advertisements can be provided together with the non-downloadable digital content. Playback of the targeted advertisements can occur before, during, or after playback of the non-downloadable digital content. Furthermore, the amount of the non-downloadable digital content allowed to be played at the user device can be based on the number of targeted advertisements viewed.

In various embodiments, outputting the at least one interactive viewer test can further comprise outputting to the user device one or more times throughout the targeted advertisement(s) a test answer message and a list of answer choices. The test answer message can comprise a single distorted letter or digit that appears at a random location at random time intervals, while the list of answer choices can comprise multiple letter or digit choices including the test answer message. In various embodiments, the test answer message can comprise a single undistorted letter or digit that appears at a random location at random time intervals, while the list of answer choices can comprise multiple distorted letter or digit choices including the test answer message. Embodiments can further comprise verifying that the user selects the matching letter or digit from the list of answer choices for each test answer message occurrence on the first attempt and within an allotted time period. Embodiments can further comprise outputting to the user device one or more times before or after playback of the at least one targeted advertisement (for example, between commercial segments) an audio test answer message and a list of answer choices. The audio test answer message can comprise a single spoken letter or digit. The list of answer choices can comprise multiple distorted letter or digit choices including the audio test answer message. Embodiments can further comprise verifying that the user selects the matching letter or digit from the list of answer choices for each audio test answer message occurrence on the first attempt and within an allotted time period.

While embodiments of the invention have been described above, it is evident that many alternatives, modifications and variations will be apparent to those skilled in the art. Accordingly, the embodiments of the invention, as set forth above, are intended to be illustrative, and should not be construed as limitations on the scope of the invention. Various changes may be made without departing from the spirit and scope of the invention. Accordingly, the scope of the present invention should be determined not by the embodiments illustrated above, but by the claims appended hereto and their legal equivalents.

What is claimed is:

1. A method comprising:
providing digital content to a user device;
providing at least one targeted advertisement to the user device, the at least one targeted advertisement comprising one or more files that are separate from the digital content;
outputting at least one interactive viewer test to the user device during playing of the at least one targeted advertisement, the interactive viewer test comprising at least one question prompting user response, the at least one question being contextually unrelated to the content of the at least one targeted advertisement; and
allowing playback of the digital content by the user device upon successful validation of the user response to the at least one interactive viewer test.

2. The method of claim 1, further comprising:
selecting the at least one targeted advertisement based on the location of the user device.

3. The method of claim 1, further comprising:
outputting one or more advertisement links to the user device, in which each of the advertisement links is contextually related to the at least one targeted advertisement;
collecting into an ad cart each advertisement link selected at the user device;
outputting the ad cart at the user device; and
redirecting a browser application of the user device to a Uniform Resource Locator associated with one of the advertisement links upon receiving a user selection of the advertisement link from the ad cart.

4. The method of claim 1, wherein allowing playback further comprises:
receiving a license key if both the content of the user responses to the interactive viewer test and the order in which the user responses are received are determined to be correct; and
allowing playback of the digital content responsive to the license key.

5. The method of claim 1, further comprising:
outputting a continent selection page to the user device;
outputting at least one country selection page to the user device, the at least one country selection page comprising a first set of countries for which digital content is available;
receiving country selections from the user device, the country selections indicating one or more of countries from the first set of countries;
outputting at least one country-specific content page to the user device, the country-specific content page comprising links to country-specific digital content;
receiving user selections from the user device, the user selections indicating one or more items of content; and
receiving category selections from the user device, wherein the at least one targeted advertisement is based on the received category selections.

6. The method of claim 5, further comprising:
providing a plurality of channels for each category; and
associating multiple commercial segments of the same category with each channel, wherein each commercial segment has a segment period, and wherein the commercial segment playback start time for each channel is offset by an amount of time equal to the segment period divided by the number of channels for the category.

7. The method of claim 1, wherein the user can be provided the capability to use, view, or play the digital content on more than one user device in exchange for viewing additional amounts of targeted advertisements.

8. The method of claim 1, wherein providing digital content further comprises:
downloading a digital file to the user device in response to a request for the file received from the user device.

9. The method of claim 1, wherein outputting the at least one interactive viewer test further comprises:
outputting to the user device one or more times throughout the at least one targeted advertisement a test answer message and a list of answer choices, wherein the test answer message comprises a single letter or digit that appears at a random location at random time intervals, and wherein the list of answer choices comprises multiple distorted letter or digit choices including the test answer message;
verifying that the user selects the matching letter or digit from the list of answer choices for each test answer message occurrence on the first attempt and within an allotted time period;
outputting to the user device one or more times before or after the at least one targeted advertisement an audio test answer message and a list of answer choices, wherein the audio test answer message comprises a single spoken letter or digit, and wherein the list of answer choices comprises multiple distorted letter or digit choices including the audio test answer message;
verifying that the user selects the matching letter or digit from the list of answer choices for each audio test answer message occurrence on the first attempt and within an allotted time period.

10. The method of claim 1, wherein providing the at least one targeted advertisement further comprises:
determining user eligibility to receive the at least one targeted advertisement based on the user device being located in a country for which targeted advertisements are available.

11. The method of claim 1, wherein the digital content comprises non-downloadable digital content.

12. The method of claim 11, in which the at least one targeted advertisement is provided together with the non-downloadable digital content, and wherein playback of the at least one targeted advertisement occurs before, during, or after playback of the non-downloadable digital content, and wherein the amount of the non-downloadable digital content allowed to be played at the user device is based on the number of targeted advertisements viewed.

13. The method of claim 1, wherein the interactive viewer test is a timed Turing test capable of distinguishing human input from non-human input.

14. A content access system, comprising:
at least one product web server configured to output a continent selection page, at least one country selection page, and at least one country-specific content selection page to a user device;
at least one product file server configured to output digital content to the user device;
at least one ad web server provided in communication with the ad interactive web interface;
at least one ad content server configured to output at least one category selection page and at least one targeted advertisement to the user device;
an ad cart;
a product interactive web interface provided in communication with the at least one product web server and the at least one product file server; and
an ad interactive web interface provided in communication with the at least one ad content server and the at least one ad web server and configured to output a plurality of commercial segments and further configured to perform at least one interactive viewer test during one or more of the commercial segments, the at least one interactive viewer test being unrelated to the content of the one or more commercial segments;
wherein the user device is further configured to allow viewing or playing of the digital content at the user device upon successful validation of the user response to the at least one interactive viewer test.

15. The content access system of claim 14, further comprising:
an interface to a license clearing house, wherein the user device is further configured to allow digital content activation in response to receiving a license key.

16. The content access system of claim 14, wherein each commercial segment has a segment period, and wherein the commercial segment playback start time for each of a plurality of channels is offset by an amount of time equal to the segment period divided by the number of channels.

17. A computer readable medium upon which is embedded a sequence of programmed instructions which when executed by a processor will cause the processor to perform the following steps comprising:
providing digital content to a user device;
providing at least one targeted advertisement to the user device, the at least one targeted advertisement comprising one or more files that are separate from the digital content;
outputting at least one interactive viewer test to the user device during playing of the at least one targeted advertisement, the at least one interactive viewer test comprising at least one question prompting user responses, the at least one question being contextually unrelated to the content of the at least one targeted advertisement; and
providing a license key to allow playback of the digital content by the user device upon successful validation of the user response to the at least one interactive viewer test.

18. The computer readable medium of claim 17, wherein the instruction further comprise:
selecting the at least one targeted advertisement based on the location of the user device.

19. The computer readable medium of claim 17, wherein the instructions further comprise:
outputting a continent selection page to the user device;
outputting at least one country selection page to the user device, the at least one country selection page comprising a first set of countries for which digital content is available;
receiving country selections from the user device, the country selections indicating one or more of countries from the first set of countries;
outputting at least one country-specific content page to the user device, the country-specific content page comprising links to country-specific digital content;
receiving user selections from the user device, the user selections indicating one or more items of content; and
receiving category selections from the user device, wherein the at least one targeted advertisement is based on the received category selections.

20. The computer readable medium of claim 19, wherein the instructions further comprise:
providing a plurality of channels for each category; and
associating multiple commercial segments of the same category with each channel, wherein each commercial segment has a segment period, and wherein the commercial segment playback start time for each channel is offset by an amount of time equal to the segment period divided by the number of channels for the category.
